(19) United States
(12) Patent Application Publication
(10) Pub. No.: US 2025/0008972 A1
(43) Pub. Date: Jan. 9, 2025

(54) Processed Cheese With Cultured Dairy Components And Method Of Manufacturing

(71) Applicant: Kraft Foods Group Brands LLC, Chicago, IL (US)

(72) Inventors: Zuoxing Zheng, Buffalo Grove, IL (US); Ammar N. Chinwalla, Gurnee, IL (US); Christine D. Marcus-Johnson, Chicago, IL (US); Divya Shree Reddy, Lake Zurich, IL (US)

(21) Appl. No.: 18/892,147

(22) Filed: Sep. 20, 2024

Related U.S. Application Data
(63) Continuation of application No. 17/884,896, filed on Aug. 10, 2022, now Pat. No. 12,108,770.
Application No. 17/884,896 is a continuation of application No. 16/536,494, filed on Aug. 9, 2019, now Pat. No. 11,464,238.
Application No. 16/536,494 is a division of application No. 13/973,660, filed on Aug. 22, 2013, now Pat. No. 10,375,972.
(60) Provisional application No. 61/692,129, filed on Aug. 22, 2012.

(51) Int. Cl. A23C 19/032; A23C 19/082; A23C 19/11

(52) U.S. Cl. CPC A23C 19/0323; A23C 19/082; A23C 19/11; A23C 2220/206; A23V 2400/231

(57) ABSTRACT

A processed cheese composition and methods of making the processed cheese composition are provided. The processed cheese composition includes natural cheese, dairy materials and a cultured dairy component. The raw cheese is provided in a range of about 10 to about 90 weight %. The dairy materials are provided in a range of about 5 to about 50 weight % and include at least one of the group consisting of milk protein concentrate, whey protein concentrate, whey, milkfat and cream. The cultured dairy component is provided in a range of about 1 to about 20 weight % and includes an antibacterial material and/or antibacterial producing bacterial culture in combination with an exopolysaccharide and/or an exopolysaccharide producing culture.

### CROSS-REFERENCE TO RELATED APPLICATIONS

This application is a continuation of U.S. application Ser. No. 17/884,896, filed Aug. 10, 2022, which is a continuation of U.S. application Ser. No. 16/536,494, filed Aug. 9, 2019, now U.S. Pat. No. 11,464,238, which is a divisional of U.S. application Ser. No. 13/973,660, filed Aug. 22, 2013, now U.S. Pat. No. 10,375,972, which claims the benefit of U.S. Provisional Application No. 61/692,129, filed Aug. 22, 2012, which are hereby incorporated herein by reference in their entireties.

### SUBMISSION OF SEQUENCE LISTING

The Sequence Listing associated with this application is filed in electronic format as an XML file on Oct. 11, 2022 and is hereby incorporated into the specification in its entirety. The name of the XML file containing the Sequence Listing is “Sequence Listing.xml.” The size of the XML file is 64 KB and the XML file was created on Oct. 11, 2022.

### FIELD

The present application generally relates to processed cheese compositions and methods for manufacture, and more particularly, processed cheese compositions containing cultured dairy components.

### BACKGROUND

Processed cheese, widely available in sliced and loaf forms, has become one of the more popular selling cheese products. Processed cheese products are particularly popular with children. Processed cheese is conventionally prepared by heating, grinding and/or mixing one or more varieties of milk-fat containing natural cheeses, such as, for example, Cheddar cheese, Colby cheese, Swiss cheese, Brick cheese, Muenster cheese, pasta filata cheese, washed curd, and granular curd cheese to suggest but a few types. The resulting cheese is then blended with other dairy products, such as non-fat dry milk and whey solids, and emulsifying salts, such as disodium phosphate, at temperatures which are sufficiently elevated to pasteurize the cheese and to produce a homogeneous, pumpable, fluid cheese material that may be formed into sheets, slices, or other desired forms.

It is often desirable to prolong the shelf life of food, such as processed cheese, and/or increase microbiological stability of such food. By increasing the amount of time a food is stable, processors can mitigate inventory losses due to spoiled foodstuffs. Prior methods, such as the use of packaging, preservatives, and/or specific storage parameters (e.g., refrigeration), have been used to stave off spoilage.

In particular, Listeria monocytogenes and C. botulinum can, in some instances, be a concern with foods like as raw milk, cheeses (particularly soft-ripened varieties), ice cream, raw vegetables, fermented raw meat sausages, raw and cooked poultry, raw meats (of all types), and raw and smoked fish. The ability of these pathogens to grow, in some instances, at temperatures as low as 3° C. permits multiplication in refrigerated foods.

Furthermore, while it is desired to provide improved shelf life to foods, such as processed cheese, there also has been an increased desire to provide foods that contain an increased amount of natural ingredients. In this regard, it may be desirable to provide foods which include only natural ingredients or otherwise remove artificial materials. For example, processed cheese oftentimes utilizes preservatives such as sorbic acid to improve food safety and shelf life. It may be desirable to incorporate natural preservatives and/or antimicrobials while maintaining and/or improving the characteristics of the processed cheese.

### SUMMARY

In one approach, a processed cheese including natural antimicrobials is provided herein. In one aspect of this approach, the processed cheese includes about 10 to about 90 percent natural cheese or a mixture of natural cheeses; one or more optional emulsifiers; about 8 to about 25 percent protein; and about 10 to about 30 percent fat. The processed cheese also includes an amount of nisin, effective to prevent toxin formation from C. botulinum determined by toxin bioassay with mice, in the processed cheese at the protein and the fat levels thereof for about 9 days at 86° F. At the same time, the processed cheese also includes an amount of exopolysaccharide effective to increase the melt of the processed cheese and increase the firmness of the processed cheese relative to a processed cheese without nisin and exopolysaccharide. In some approaches, the nisin includes nisin A.

The nisin and exopolysaccharide of the processed cheese may also be included in the processed cheese in the form of a cultured dairy component, which may be provided in about 1 to about 20 percent in the processed cheese. The nisin and the exopolysaccharide in the cultured dairy component may also be obtained from a fermentation of a single bacterial strain in a liquid dairy medium, where the bacterial strain is an isolated Lactococcus lactis strain having all of the identifying characteristics of the Lactococcus lactis strain of ATCC PTA-120552.

The processed cheese may include about 1 to about 100 ppm of nisin and about 100 to about 2,000 ppm of the exopolysaccharide, where the nisin and exopolysaccharide may be obtained from a single bacterial strain, where the bacterial strain is an isolated Lactococcus lactis strain having all of the identifying characteristics of the Lactococcus lactis strain of ATCC PTA-120552.

The fermentation of the bacterial strain ATCC PTA-120552 may be conducted in a 2× to a 5× concentrated liquid dairy medium at a temperature of about 25 to about 35° C. and a pH of about 5 to about 6 for about 15 to about 48 hours. The concentrated liquid dairy medium may be a concentrated milk having a total solids of about 5 to about 36 percent, about 1 to about 14 percent protein, and about 0 to about 16 percent fat.

In some approaches, the processed cheese is free of artificial preservatives selected from the group consisting of sorbic acid, potassium sorbate, nitrites, and combinations thereof.

In some approaches, the processed cheese includes nisin A and a bacterial strain having at least one gene from a nisin producing gene cluster with significant homology to the sequences selected from the group consisting of SEQ ID NOS 9 to 19 and at least one gene from an exopolysaccharide producing gene cluster with significant homology to the sequences selected from the group consisting of SEQ ID NOS 21 to 33. In some approaches, the at least one gene from a nisin producing gene cluster and the at least one gene from the exopolysaccharide producing gene cluster are from the same bacterial strain, where the bacterial strain may be an isolated Lactococcus lactis strain having all of the identifying characteristics of the Lactococcus lactis strain of ATCC PTA-120552. The bacterial strain incorporated into the processed cheese product may not be viable due to heat treatment steps in either the process for preparing the cultured dairy component or processed cheese product.

In other aspects, a method of producing a processed cheese having natural antimicrobials is provided. In some approaches, the method includes fermenting a liquid dairy medium with a Lactococcus lactis strain to produce a cultured dairy component including nisin and exopolysaccharide. The cultured dairy component is then blended with a natural cheese or mixture of natural cheeses and one or more emulsifiers to produce a processed cheese having about 8 to about 25 percent protein and about 10 to about 20 percent fat. The method is effect to produce processed cheese an amount of nisin, effective to prevent toxin formation from C. botulinum determined by toxin bioassay with mice, in the processed cheese at the protein and the fat levels thereof for about 9 days at 86° F. The method is also effective to produce processed cheese with an amount of exopolysaccharide effective to increase the melt of the processed cheese and increase the firmness of the processed cheese relative to a processed cheese without nisin and exopolysaccharide. In some approaches, the nisin includes nisin A.

In other approaches, the nisin and the exopolysaccharide in the cultured dairy component of the method are obtained from the fermentation of the same Lactococcus lactis strain in the liquid dairy medium. The Lactococcus lactis strain may be an isolated Lactococcus lactis strain having all of the identifying characteristics of the Lactococcus lactis strain of ATCC PTA-120552. The cultured dairy component used in the method may also include about 1 to about 100 ppm of nisin and about 100 to about 2000 ppm of the exopolysaccharide. The processed cheese may include about 1 to about 20 percent of the cultured dairy component.

The method may include the fermentation of the Lactococcus lactis strain ATCC PTA-120552 conducted in a 2× to a 5× concentrated liquid dairy medium at a temperature of about 25 to about 35° C. and a pH of about 5 to about 6 for about 15 to about 48 hours. In some approaches, the concentrated liquid dairy medium is a concentrated milk having a total solids of about 5 to about 36 percent, about 1 to about 14 percent protein, and about 0 to about 16 percent fat.

In other approaches, the method is effective so that the processed cheese is free of artificial preservatives selected from the group consisting of sorbic acid, potassium sorbate, nitrites, and mixtures thereof.

In some approaches, the cultured dairy component of the method includes nisin A and a bacterial strain having at least one gene from a nisin producing gene cluster with significant homology to the sequences selected from the group consisting of SEQ ID NOS 9 to 19 and at least one gene from an exopolysaccharide producing gene cluster with significant homology to the sequences selected from the group consisting of SEQ ID NOS 21 to 33.

In other approaches, the at least one gene from a nisin producing gene cluster and the at least one gene from the exopolysaccharide producing gene cluster in the method are from the same Lactococcus lactis strain.

### BRIEF DESCRIPTION OF THE DRAWINGS

FIG. 1 is a process flow diagram illustrating production of an exemplary cultured dairy component produced from a concentrated dairy liquid;

FIG. 1A is an alternative process flow diagram;

FIG. 2 is a process flow diagram illustrating a second form of production of an exemplary cultured dairy component produced from powdered dairy ingredients;

FIG. 3 illustrates taste profiles for processed cheese with and without cultured dairy components;

FIGS. 4A-4D are photographs showing melt comparisons for various processed cheeses with and without cultured dairy components;

FIGS. 5A-5C are photographs showing melt comparisons for various processed cheeses with and without cultured dairy components;

FIG. 6 is a graph showing the firmness measurements for processed cheese with 8 percent cultured dairy components compared to a control without cultured dairy components;

FIG. 7 is a graph showing the consistency measurements for processed cheese with 8 percent cultured dairy components compared to a control without cultured dairy components;

FIG. 8 is a graph showing the firmness measurements for processed cheese with 8 percent cultured dairy components compared to a control without cultured dairy components;

FIG. 9 is a graph showing the consistency measurements for processed cheese with 8 percent cultured dairy components compared to a control without cultured dairy components;

FIG. 10 is a chart showing the results of a comparative Multi Locus Sequence Typing (MLST) analysis of nisin-producing strains;

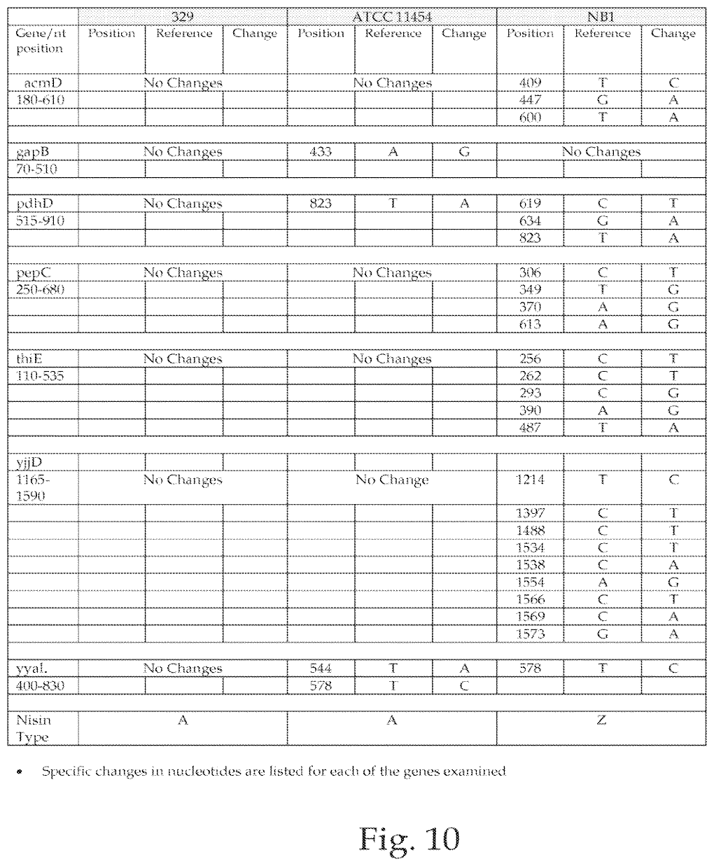

FIG. 11 is a chart showing the results of phage typing analysis of nisin-producing strains;

FIG. 12 includes results of Riboprinter analysis of various Lactococcus lactis strains;

FIG. 13 is a chart comparing the EPS-related genes of various lactic acid bacteria;

FIG. 14 shows the amino acid sequence of nisin A; and

FIG. 15A is a scanning confocal microscopy images showing the absence of EPS prior to inoculation and fermentation with L. lactis strain 329 and FIG. 15B is a scanning confocal microscopy images showing the presence of EPS after fermentation with L. lactis strain 329.

### DETAILED DESCRIPTION

The present application is generally directed to processed cheese including, among other aspects, natural antimicrobials and natural texture modifying agents. In one form, the natural antimicrobials are incorporated into the processed cheese via cultured dairy components or concentrated cultured dairy components, which include a natural antimicrobial and/or a culture capable of producing a natural antimicrobial under appropriate fermentation conditions. As used herein, the terms “cultured dairy component” or “concentrated cultured dairy component” generally refer to cultured milk substrates or derivatives thereof that have undergone, in some approaches, concentration and fermentation with selected antimicrobial-producing cultures under conditions effective to produce antimicrobials unless specifically identified as not including cultured antimicrobials. As used herein, “natural antimicrobial” refers to a component with antimicrobial activity that is produced by an organism, such as by a bacterial culture during a fermentation process.

In one form, the cultured dairy component includes a dairy substrate fermented with an antimicrobial-producing culture. In some approaches, the dairy substrate is a dairy liquid, such as milk or a concentrated dairy liquid or milk substrate, such as a 2-5× concentrated milk substrate. In one aspect, the antimicrobial-producing culture is a nisin-producing culture. In one particular form, the nisin produced by the culture is nisin A. In one approach, the processed cheeses herein include about 1 to about 100 ppm of nisin, in other approaches, about 1 to about 20 ppm of nisin, in other approaches, about 5 to about 15 ppm of nisin, and in yet other approaches, about 10 to about 15 ppm of nisin.

In some approaches, the cultured dairy component also includes exopolysaccharide (EPS). In one aspect, the EPS is produced during fermentation of the milk substrate under the same conditions and with the same medium used to produce nisin. In another aspect, the EPS is produced by the antimicrobial-producing culture and, in some approaches, from the same bacterial strain used to produce nisin. In this regard, when the cultured dairy component is used in the processed cheeses herein, the processed cheese includes both nisin (such as nisin A) and EPS obtained from the same fermentation, and in some approaches, the same bacterial strain. Along with the nisin discussed above, it is expected that the cultured dairy component includes about 0.1 to about 2 percent of exopolysaccharide, and the final processed cheese includes, in addition to the nisin, about 100 to about 1000 ppm of the exopolysaccharide.

It has been unexpectedly found that a processed cheese including the cultured dairy component herein including both natural antimicrobials (such as nisin) and exopolysaccharide from the same fermentation and/or same bacterial strain has improved antimicrobial properties, improved melt performance, and firmer texture as compared to processed cheese with the same formulation except artificial preservatives and/or other types of prior natural anti-microbials. At the same time, the processed cheese herein including the unique cultured dairy component also exhibits a firmness resembling that of natural cheese. It was unexpected that both increased melt properties and increased firmness could be obtained at the same time in a processed cheese. By one approach, the processed cheeses herein exhibit a firmness (Young's modulus) of about 1500 to about 2500 Pa and, at the same time, exhibit a consistency of about 50,000 to about 70,000 Pa/second. In other approaches, the processed cheese with the cultured dairy components also exhibits an increase in melt of about 20 to about 75% over the same processed cheese but without the cultured dairy component or with sorbic acid or other artificial preservative instead of the cultured dairy component. As used herein, natural cheese refers to unpasteurized cheese made by curdling milk or other dairy liquid using some combination of rennet (or rennet substitute) and acidification. The natural cheese used in the processed cheese described herein may be freshly made or aged.

As discussed more below, prior antimicrobials tended to be less effective in the context of a processed cheese with high levels of protein and fat because it was believed that the levels of protein and fat in processed cheese combined, in some cases, with lower moisture levels tended to protect and/or shield various pathogens from being inhibited by commercial forms of nisin and other natural antimicrobials. It was unexpectedly discovered that the natural antimicrobials of the cultured dairy components herein effectively inhibit C. botulinum and other pathogens at a level not found by prior natural antimicrobials.

Previously, it was expected that when melt performance of processed cheese was improved, it resulted in a decrease in firmness. That is, it was previously expected there was an inverse relationship between melt and firmness. As mentioned above, the processed cheeses herein, on the other hand, achieve an improvement in both melt and texture/firmness at the same time when the cultured dairy components are used. This double improvement in melt and firmness at the same time tended to be opposite to these trends in previous processed cheese applications.

As described herein, the term activity unit (“AU”) may be used to describe the biological activity of the natural antimicrobial in the cultured dairy component and processed cheese in which the antimicrobial is incorporated. It should be understood that biological activity may also be expressed in International Units (“IU”) such that AU and IU may be used interchangeably. In some approaches, the cultured dairy components of the present disclosure and the processed cheeses prepared therewith may have nisin activity in the processed cheese of about 40 to about 400 IU/gram and, in other approaches, about 50 to about 200 IU/gram.

One or more different natural antimicrobials may be included in the processed cheese. In one form, the processed cheese contains a sufficient amount of natural antimicrobial such that the processed cheese does not contain or is free of artificial preservatives, such as sorbic acid, potassium sorbate and the like. As used herein, the phrases “does not contain,” “is free of” or “substantially free of” mean less than about 0.5%, in other approaches, less than about 0.1% and, in some cases, less than about 0.05% and in other cases, none. In some approaches, the processed cheese includes an amount of natural antimicrobial effective to prevent toxin formation for at least about 9 days when the processed cheese is stored at about 86° F. The processed cheese also includes cultured dairy component in an amount effective to prevent more than 1 log of growth of Listeria monocytogenes for at least about 4 weeks, in another aspect at least about 8 weeks, in another aspect at least about 12 weeks, in another aspect at least about 16 weeks, in another aspect at least about 20 weeks, in another aspect at least about 24 weeks, and in yet another aspect at least about 28 weeks, during storage at about 1 to about 10° C.

The natural antimicrobial can be produced by fermentation using an antimicrobial-producing strain of lactic acid bacteria. As used herein, the term “lactic acid bacteria” generally refers to gram-positive bacteria that generate lactic acid as a major metabolite of carbohydrate fermentation. The lactic acid bacteria may be, for example, an antibacterial producing strain of Lactococcus lactis or, in alternative approaches, Brevibacterium linens.

In some aspects, the natural antimicrobial comprises nisin and, in some approaches, nisin A. Nisin is an inhibitory polycyclic peptide with 34 amino acid residues. It contains the uncommon amino acids lanthionine, methyllanthionine, dehydroalanine and dehydro-amino-butyric acid. These amino acids are synthesized by posttranslational modifications. In these reactions a ribosomally synthesized 57-mer is converted to the final peptide. The unsaturated amino acids originate from serine and threonine.

Nisin can be obtained by culturing nisin-producing bacteria on natural substrates, including milk. Nisin has been included in food products to extend the safe, usable life by suppressing gram-positive spoilage and pathogenic bacteria. Due to its highly selective activity, it may also be employed as a selective agent in microbiological media for the isolation of gram-negative bacteria, yeast and molds. Two commercially available antimicrobials containing nisin are Nisaplin® and Novasin™ (both from Daniso A/S, Denmark). Typically, Nisaplin contains less than about 3.0 weight % nisin, the remainder consisting of NaCl, proteins, carbohydrates and moisture. When referring to a nisin component herein the component may include not only nisin, but also other ingredients, such as carriers, salts, protein, carbohydrates, and metabolites that result from the fermentation process. As shown in the Examples and discussed more below, commercially available sources of nisin do not provide the level of suppression of spoilage and pathogenic bacteria in the context of processed cheese as the cultured dairy components of the present disclosure.

In one aspect, the cultured dairy components made by the methods described herein include nisin A and/or the nisin-producing culture includes a nisin A-producing culture. Nisin A has a molecular weight of about 3,351.5 Da and the amino acid sequence of SEQ ID NO 1. However, it should be understood that other natural antimicrobials may also be utilized. For example, other forms of nisin, including Nisin Z, Nisin Q, Nisin F, and Nisin F, may be included. Other bacteriocins may also be included, such as class I bacteriocins, class II bacteriocins, class III bacteriocins, and class IV bacteriocins. Other natural antimicrobials include naturally produced antifungal agents such as, for example, natamycin (produced by Streptomyces natalensis) and polylysine (produced by certain Streptomyces species) may also be included.

Further, bacterial strains that produce natural antimicrobials may be provided. Such bacterial strains include, for example, antibacterial-producing strains of lactic acid bacteria, such as for example, nisin-producing strains of Lactoccocus lactis or Brevibacterium linens.

In one form, the cultured dairy component comprises a nisin component and/or includes a culture capable of producing a nisin component in the range of about 30 to about 90 ppm by weight of the fermentation medium.

The natural antimicrobial can be provided by culturing the antimicrobial-producing bacteria under appropriate fermentation conditions in a dairy substrate. The dairy substrate may include, for example, milk, cream, whey or other dairy-containing powder or liquid. The dairy substrate may also comprise dextrose, corn syrup or other carbohydrates supplemented with other nutrients for bacterial growth, with or without an acid neutralizer such as calcium carbonate.

In some forms, the milk may be in the form of raw milk or a concentrated milk product, such as at least about 2× concentrated milk product, in another aspect up to about 5× concentrated milk product. Typically, the milk base will container greater than about 3 percent lactose and a nitrogen source. The base can be produced from hydrated powders or derived from fresh dairy liquids, such as skim milk, two-percent milk, whole milk, and the like. By one approach, the starting dairy substrate includes concentrated milk having a total solids of about 5 to about 36, a protein content of about 1 to about 14 percent, a fat content of about 0 to about 16 percent, and a moisture content of about 64 to about 95 percent.

When the cultured dairy component is used in production of processed cheese, it has been found to be desirable to maintain a low level of moisture in the dairy substrate to reduce the increased costs associated with removing moisture from the cultured dairy component prior to inclusion in the processed cheese product. Further, certain components of the cultured dairy component may be unstable and may be degraded or otherwise damaged during a moisture removal process. For example, the EPS component of the cultured dairy component is believed to be relatively unstable and may be damaged by moisture removal techniques, such as spray drying, evaporation, and the like. However, the cultured dairy component including cultured antimicrobials may take a variety of forms such as liquid and/or powder, if desired for a particular application.

At least in some approaches, the nisin A and exopolysaccharide-producing culture used herein is Lactococcus lactis ss. lactis strain 329. On Aug. 21, 2013, strain 329 was deposited at the American Type Culture Collection (ATCC), 10801 University Blvd., Manassas, VA 20110, and given accession number PTA-120552. The deposit was made under the provisions of the Budapest Treaty on the International Recognition of the Deposit of Microorganisms for the Purposes of Patent Procedure.

It has been found that Lactococcus lactis strain 329 has a unique genetic and phage profile compared to other nisin-producing strains of lactic acid bacteria. Advantageously, strain 329 also was found to be able to grow in concentrated dairy substrates, including about a 2× to about a 5× milk. It has been found that few cultures are capable of growing in such highly concentrated milk substrates. For example, the cultures herein are effective to grow to at least about 109 CFU/gram in about 10 hours and produce more than about 2000 IU nisin A/gram in about 18 hours even in the about 2× to about 5× concentrated fermentation medium. Strain 329 was characterized using Multi Locus Sequence Typing (MLST), phage typing, and ribotyping as discussed more below.

### Multi Locus Sequence Typing (MLST)

The publicly available genome of L. lactis subsp. lactis IL 1403 (taxid: 272623), also a nisin-producing strain, was used as a template for selection of seven housekeeping genes to be used as genetic markers in a comparison of IL 1403 to strain 329. The selected genes cover a range of loci on the chromosome as detailed in Table 1 below. Each of the seven genes was amplified and sequenced. Sequences were then aligned and compared using IL1403 as the reference. Each sequence variation was accounted for and represents an individual allele.

TABLE 1

| Gene | Protein | Chromosome Location |
|---|---|---|
| acmD (SEQ ID NO 2) | n-acetylmuramidase | 527,413-528,498 |
| gapB (SEQ ID NO 3) | Glyceraldehyde 3 | 2,332,466-2,333,476 |
| | phosphate dehydrogenase | |
| pdhD (SEQ ID NO 4) | Lipamidedehydrogenase | 58,971-60,389 |
| | component of pyruvate | |
| | dehydrogenase | |
| pepC (SEQ ID NO 5) | Aminopeptidase C | 1,947,325-1,948,635 |
| thiE (SEQ ID NO 6) | Thiamine phosphate | 1,293,610-1,294,257 |
| | pyrophosphorylase | |
| yjjD (SEQ ID NO 7) | ABC transporter | 993,341-994,963 |
| | permease protein | |
| yyaL (SEQ ID NO 8) | GTP binding protein | 11,119-12,234 |

### Phage Typing

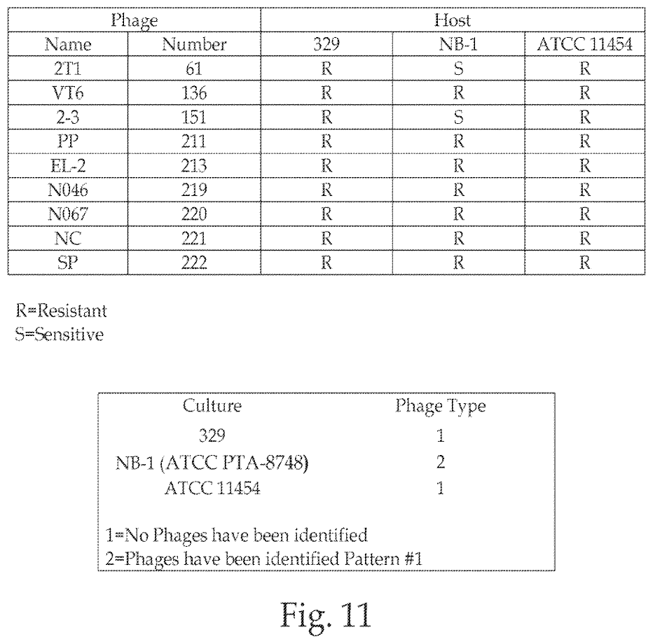

Spot plates were used for phage profiling of high titer phage stocks. The phages are identified and the results of the phage typing are presented in FIG. 11.

### Ribotyping

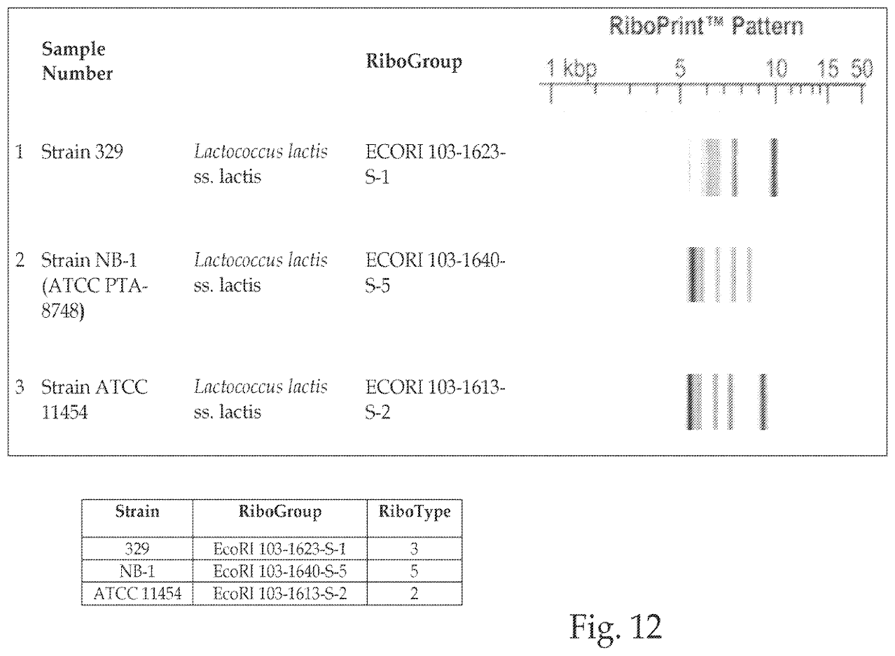

As used herein, “ribotyping” refers to fingerprinting of genomic DNA restriction fragments containing all or part of the genes coding for the 16S and 23S rRNA. Conventional ribotyping techniques utilizing EcoRI as the restriction enzyme were carried out. The results are shown in FIG. 12. Ribotyping confirmed that Lactococcus lactis strain 329 is substantially different from publicly available Lactococcus lactis strain ATCC 11454, also a nisin-producing strain.

### DNA Sequence Analysis

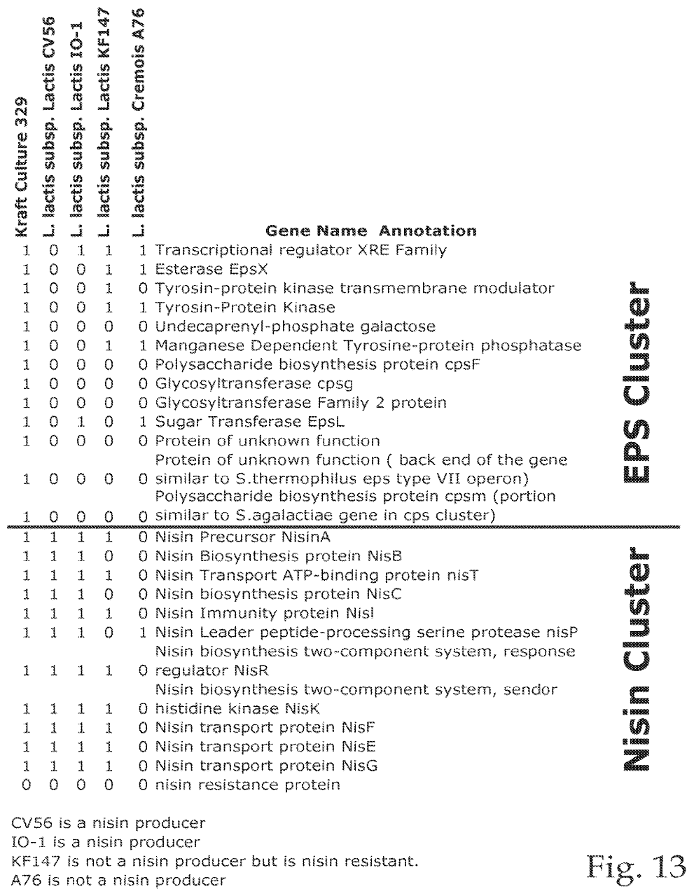

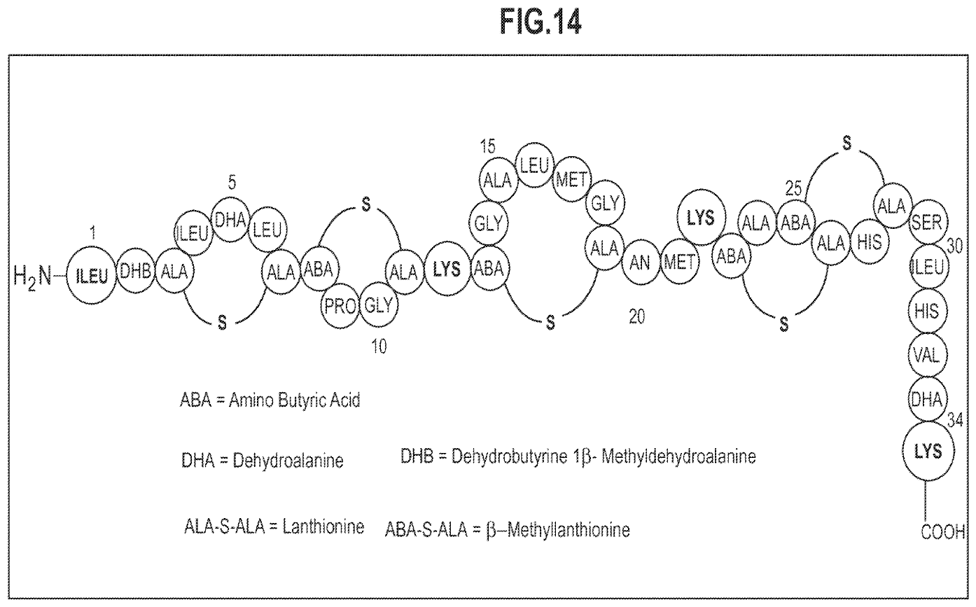

It was found that Lactococcus lactis strain 329 has a unique combination of exopolysaccharide and nisin cluster genes as shown in FIG. 13. Lactococcus lactis strain 329 includes the nisin cluster genes sequence of Table 2 below and produces nisin A having the amino acid sequence of FIG. 14 (SEQ ID NO 1).

TABLE 2

| GENE | SEQ ID Number |
|---|---|
| Nisin precursor nisin A | SEQ ID NO 9 |
| Nisin transport protein (nisG) | SEQ ID NO 10 |
| Nisin transport protein (nisE) | SEQ ID NO 11 |
| Nisin transport protein (nisF) | SEQ ID NO 12 |
| Nisin two-component system, | SEQ ID NO 13 |
| response regulator (nisR) | |
| Nisin sensor-receptor histidine | SEQ ID NO 14 |
| kinase (nisK) | |
| Nisin leader peptide-processing | SEQ ID NO 15 |
| serine protease (nisP) | |
| Nisin immunity protein | SEQ ID NO 16 |
| Nisin biosynthesis protein (nisC) | SEQ ID NO 17 |
| Nisin transport ATP-binding | SEQ ID NO 18 |
| protein (nisT) | |
| Nisin biosynthesis protein (nisB) | SEQ ID NO 19 |

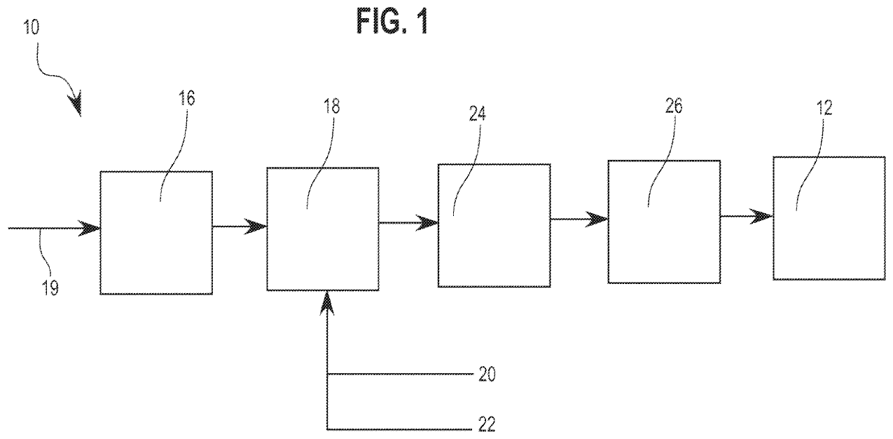

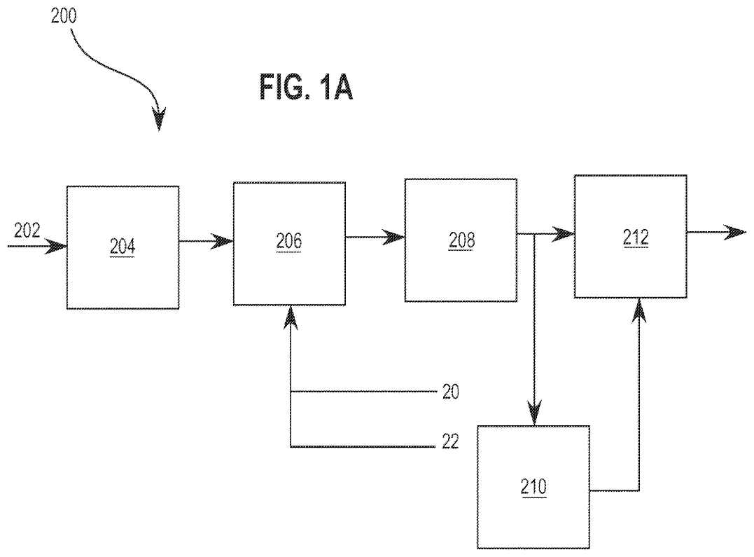

It has been found that, at least under fermentation conditions described herein with reference to the method of FIG. 1, Lactococcus lactis strain 329 produces a high level of 34-mer nisin A relative to the 57-mer nisin A precursor peptide (nisin A precursor has the amino acid sequence of SEQ ID NO 20). Nisin A is produced by posttranslational modification of the nisin A precursor. At least in some approaches, Lactococcus lactis strain 329 produces nisin A relative to nisin A precursor at a ratio of at least about 9:1, in another aspect at least about 9.5:0.5. In contrast, Danisco's Nisaplin® includes approximately 83 percent nisin A and 17 percent nisin A precursor.

Under the same fermentation conditions effective to produce nisin A described above, Lactococcus lactis strain 329 also produces exopolysaccharide, such as, for example, under fermentation conditions described herein with reference to the method of FIG. 1. Lactococcus lactis strain 329 includes the EPS cluster genes of Table 3 below:

TABLE 3

| GENE | SEQ ID Number |
|---|---|
| Transcriptional regulator, XRE family | SEQ ID NO 21 |
| Esterase (EpsX) | SEQ ID NO 22 |
| Tyrosine-protein kinase transmembrane | SEQ ID NO 23 |
| modulator (epsC) | |
| Tyrosine-protein kinase | SEQ ID NO 24 |
| Undecaprenyl-phosphate galactose | SEQ ID NO 25 |
| phosphotransferase | |
| Manganese depended tyrosine-protein | SEQ ID NO 26 |
| phosphatase | |
| Polysaccharide biosynthesis protein | SEQ ID NO 27 |
| (cpsF)/glycosyl transferase (cpsG) | |
| Glycosyl transferase (cpsG)/ | SEQ ID NO 28 |
| polysaccharide biosynthesis protein | |
| (cpsM(v)) | |
| Glycosyltransferase family 2 protein | SEQ ID NO 29 |
| Sugar transferase, (epsL) | SEQ ID NO 30 |
| Protein of unknown function, unknown | SEQ ID NO 31 |
| family | |
| Protein of unknown function, unknown | SEQ ID NO 32 |
| family/Beta-1,3-glucosyltransferase | |
| Polysaccharide biosynthesis protein | SEQ ID NO 33 |
| (cpsM(v)) | |

At least in some approaches, an antimicrobial-producing bacterial strain useful in the methods described herein is able to produce both nisin A of about 2000 IU/gram or more and exopolysaccharide under the fermentation conditions described in reference to FIG. 1.

The sequence information provided herein should not be so narrowly construed so as to require inclusion of erroneously identified nucleotides. The sequences disclosed herein can be used by one of ordinary skill in the art to isolate the complete gene from the bacterial strain and subject the gene to further sequence analysis to identify any sequencing errors.

As used herein, the terms “homology” and “identity” are used interchangeably. For purposes of determining the percent identity or homology of two sequences, the sequences may be aligned for optimal comparison purposes. The nucleotides or amino acids are then compared at corresponding nucleotide or amino acid positions of the two sequences. For example, a nucleotide or amino acid in a first sequence is considered identical to that of the second sequence when the same nucleotide or amino acid is located in the corresponding position in the second sequence. The percent identity is calculated by determining the number of identical positions divided by the total number of positions (i.e., overlapping positions) multiplied by 100.

Functional nucleic acid equivalents are also contemplated herein. For example, functional nucleic acid equivalents include silent mutations or other mutations that do not alter the biological function of the encoded polypeptide.

In one form, an antimicrobial-producing bacterial strain useful in the methods described herein has one or more genes of significant homology to SEQ ID NOS 9-19 and 21-33 and is able to produce nisin A and EPS under the same fermentation conditions. As defined herein, the term “significant homology” means at least 70 percent, in another aspect at least 75 percent, in another aspect at least 80 percent, in another aspect at least 85 percent identity, in another aspect at least 90 percent identity, in another aspect at least 95 percent identity, in yet another aspect at least 99 percent identity, and in yet another aspect complete identity.

In some approaches, an antimicrobial-producing bacterial strain useful in the methods described herein has at least two genes of significant homology to the sequences selected from the group consisting of SEQ ID NOS 9-19 and 21-33, in another aspect has at least three genes of significant homology to the sequences selected from the group consisting of SEQ ID NOS 9-19 and 21-33, in another aspect has at least four genes of significant homology to the sequences selected from the group consisting of SEQ ID NOS 9-19 and 21-33, in another aspect has at least five genes of significant homology to the sequences selected from the group consisting of SEQ ID NOS 9-19 and 21-33, in another aspect has at least six genes of significant homology to the sequences selected from the group consisting of SEQ ID NOS 9-19 and 21-33, in another aspect has at least seven genes of significant homology to the sequences selected from the group consisting of SEQ ID NOS 9-19 and 21-33, in another aspect has at least eight genes of significant homology to the sequences selected from the group consisting of SEQ ID NOS 9-19 and 21-33, in another aspect has at least nine genes of significant homology to the sequences selected from the group consisting of SEQ ID NOS 9-19 and 21-33, in another aspect has at least ten genes of significant homology to the sequences selected from the group consisting of SEQ ID NOS 9-19 and 21-33, in another aspect has at least eleven genes of significant homology to the sequences selected from the group consisting of SEQ ID NOS 9-19 and 21-33, in another aspect has at least twelve genes of significant homology to the sequences selected from the group consisting of SEQ ID NOS 9-19 and 21-33, in another aspect has at least thirteen genes of significant homology to the sequences selected from the group consisting of SEQ ID NOS 9-19 and 21-33, in another aspect has at least fourteen genes of significant homology to the sequences selected from the group consisting of SEQ ID NOS 9-19 and 21-33, in another aspect has at least fifteen genes of significant homology to the sequences selected from the group consisting of SEQ ID NOS 9-19 and 21-33, in another aspect has at least sixteen genes of significant homology to the sequences selected from the group consisting of SEQ ID NOS 9-19 and 21-33, in another aspect has at least seventeen genes of significant homology to the sequences selected from the group consisting of SEQ ID NOS 9-19 and 21-33, in another aspect has at least eighteen genes of significant homology to the sequences selected from the group consisting of SEQ ID NOS 9-19 and 21-33, in another aspect has at least nineteen genes of significant homology to the sequences selected from the group consisting of SEQ ID NOS 9-19 and 21-33, in another aspect has at least twenty genes of significant homology to the sequences selected from the group consisting of SEQ ID NOS 9-19 and 21-33, in another aspect has at least twenty-one genes of significant homology to the sequences selected from the group consisting of SEQ ID NOS 9-19 and 21-33, in another aspect has at least twenty-two genes of significant homology to the sequences selected from the group consisting of SEQ ID NOS 9-19 and 21-33, in another aspect has at least twenty-three genes of significant homology to the sequences selected from the group consisting of SEQ ID NOS 9-19 and 21-33, and in yet another aspect has at least twenty-four genes of significant homology to the sequences selected from the group consisting of SEQ ID NOS 9-19 and 21-33.

Turning to more of the specifics regarding methods of producing an effective cultured dairy concentrate and processed cheese and first referring to FIG. 1, a process flow diagram 10 is provided that illustrates one method of producing a cultured dairy material or cultured dairy concentrate 12 effective to produce both an antimicrobials (such as nisin A) and EPS from the same culture and under the same conditions, the product of which is effective for use with processed cheese. In this exemplary process 10, a liquid dairy starting material 14, such as a dairy liquid like whole milk may be used. In other approaches, the starting dairy liquid may be milk protein concentrate and or whey materials. The starting material 14 may have from about 5 to about 35% total solids, about 0 to about 16 percent fat, about 1 to about 14 percent protein, and about 64 to about 95 percent moisture. In another form, the starting material 14 is 3.5× concentrated whole milk having about 26 to about 30 percent total solids, about 10 to about 15percent fat, about 8 to about 12percent protein, and about 70 to about 70 percent moisture.

In another approach, the starting material 14 is a concentrated dairy liquid obtained from the ultrafiltration of liquid dairy milk. The concentrated starting material may be concentrated to a 2× to a 5× concentration as determined by total solids, in other approaches, about a 2× to about a 4×, and in yet other approaches, about a 3× to about a 3.5× dairy liquid. That is, a 3× concentration has 3 times the level of total solids relative to a starting dairy liquid, and a 5× concentration has about 5 times the level of total solids relative to the starting dairy liquid. In one approach, an ultra-filtration membrane may be used to achieve an appropriate concentrated starting material. One suitable membrane has a molecular weight cutoff of about 5 to about 20 KD. Other methods of concentration may also be used including microfiltration, nanofiltration, and reverse osmosis as needed for a particular application.

As discussed further below, fermentation in concentrated milks, such as the 2× to 5× milk of the present disclosure typically presents problems with prior antimicrobial cultures and fermentations. Strain 329 used within the products and methods of the present disclosure uniquely allows fermentation in a concentrated dairy liquid and, at the same time, permits formation of both nisin and EPS from the same strain and under the same fermentation conditions. By utilizing the concentrated milks for the fermentation and the ultimate production of the processed cheese ingredients herein, water content in the resultant process cheese is better controlled. The concentrated dairy components of the present disclosure combine multiple functionalities and components (i.e., such as nisin and EPS) in the same ingredient. In some approaches, this reduces the overall moisture load in the processed cheese manufacturing process and, in some cases, also simplifies the processed cheese ingredient line.

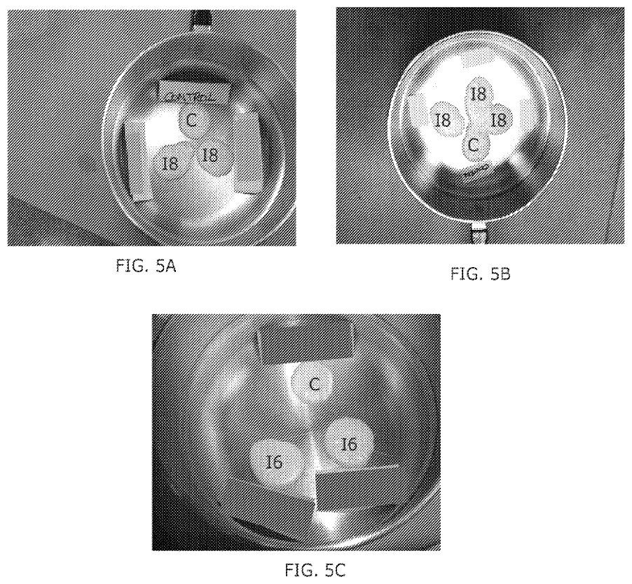

The starting material 14, which is either a liquid dairy or concentrated liquid dairy component, is then pasteurized 16 and then enters one or more fermenters 18. Pasteurization may be about 150 to about 190° F. for about 20 to about 40 seconds resulting in an exit temperature of the pasteurized starting material of about 80 to about 90° F. An antimicrobial-producing culture 20, such as Lactoccocus lactis strain 329, is added to the fermenter 18 along with a base solution 22 such as sodium hydroxide (e.g., a dilute 5.5N sodium hydroxide). In one form, about 2×10⁶ to about 2×10⁸ CFU/ml of the antimicrobial-producing culture 20 is added to the fermenter. In one embodiment, the culture 20 is a thawed form of the culture. In one approach, the fermentation temperature is maintained at about 25 to about 35° C. (in some approaches about 28 to about 32° C., and in other approaches, about 30° C.) and a pH of about 5 to about 6 (in other approaches, about 5.4 to about 5.8, and in yet other approaches, about 5.4 to about 5.6) in the fermenter. Other temperatures and pH's may also be used if the culture is able to produce nisin and EPS at desired levels under the selected conditions. For example, in one approach, the pH ranges from about 5 to about 7 and the temperature ranges from about 20 to about 40° C. The composition may be fermented over a variety of different time periods to impart different flavor characteristics to the composition. For example, in one approach, the composition is fermented for about 18 to about 22 hours. In another form, the fermentation may take place over a range of about 15 to about 48 hours. As shown in FIG. 5, by varying the fermentation time, the flavor of the cultured dairy component, and resultantly the processed cheese flavor, may be modified.

The composition is next sent to an optional shear device 24 to shear small/soft curds that may have formed. In one approach, the shear device may be a rotor/stator mixer (such as a Dispax) or other rotor shear device. This step may be optional depending on the other processing conditions as well as the properties of the materials utilized in the process. The composition is then finally subjected to an optional heat treatment step 26. In one form, the composition is heat treated 26 at about 150° F. to about 160° F. for approximately about 60 to about 100 seconds. In another form, the composition is heat treated to reduce CFU/ml to less than about 1000 CFU/ml. The resulting composition 12 is a cultured dairy component or cultured dairy concentrate that includes nisin and/or a nisin-producing material and, at the same time, EPS and/or an EPS-producing material. At least in some approaches, these two components are advantageously produced from the same starting bacterial strain, such as strain 329, and under the same fermentation conditions. The composition may be in the form of a liquid having approximately 6 to about 40% total solids. In one form, the liquid has approximately 20 to about 30% total solids, and in some approaches about 28.5% total solids.

In an alternative method 200 shown in FIG. 1A, hydrated powders and/or liquid milk 202 may be first heated 204, such as in a high temperature, short time sterilization (HTST) or an ultra-high temperature (UHT) sterilization process step. Next, the heated liquid is then fermented 206 with similar materials, cultures, and conditions as described with respect to the previously discussed method. After fermentation, the material may be optionally sheared 208 and then concentrated 210. In this approach, concentration may be membrane filtration, evaporation, or centrifugation. After concentration, the resultant concentrate may be optionally heated 212 again using HTST or UHT, for example.

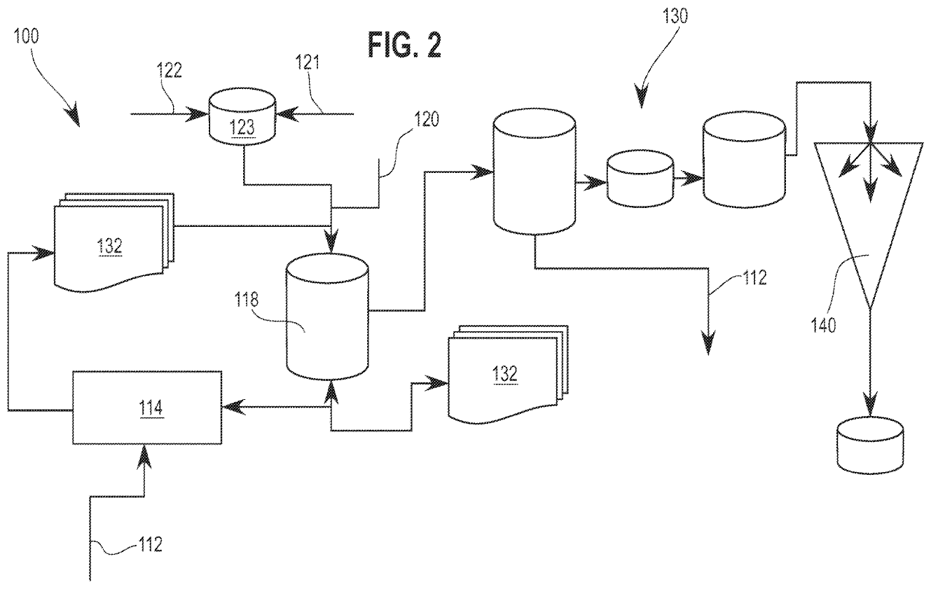

Another process 100 for preparing cultured dairy components is illustrated in FIG. 2. The process 100 in FIG. 2 utilizes powdered starting materials 112 such as powdered milk protein concentrate and powdered whey. In this approach, about 3 to about 10 percent powdered milk protein concentrate, about 2 to about 6 percent powdered whey, and about 75 to about 95 percent water are blended in a tank or a fermenter 118 to form the fermentation medium. The powders may be mixed 114 and hydrated prior to being added to the fermenter 118. These starting materials are then combined with an antimicrobial-producing culture 120, such as Lactococcus lactis strain 329, in an amount of about 2×10⁶ CFU/ml to about 2×10⁸ CFU/ml in the fermentation vessel 118 and fermented in a similar manner as described for FIG. 1. Similar to the method of FIG. 1, process water and a base, such as a dilute sodium hydroxide may also be added to the fermentation vessel 118 from tank 123. After fermentation, the composition may optionally be heated or cooled as necessary and then prepared into a final cultured dairy component 112. In some approaches, the process may include various intermediate heating and cooling 132 as needed for a particular application. In this regard, the composition 112 may be placed in one or more holding tanks 130 or other storage location for use in a concentrated liquid form. Holding tank temperatures may be about 30 to about 50° F. In one embodiment (such as in a liquid form), the cultured dairy component has from about 6 to about 11% total solids and in another form, about 20% total solids. Further, the cultured dairy component may be spray-dried, such as in an atomizer 140. In one approach, the atomizer may have a dryer temperature of about 160 to about 180° F. and about a 15 to about 25 psi pressure drop.

The cultured dairy component may take a variety of forms. For example, as shown in FIGS. 1 and 2, the cultured dairy component may be in the form of a liquid. The cultured dairy component may also take the form of a powder, such as from spray drying as shown in FIG. 2. Furthermore, the cultured dairy component may also be in a concentrated form, such as components obtained by evaporation, filtering and the like. The resulting product of the method from FIG. 1 or 2 may be either a liquid or spray dried depending on the particular application. FIG. 2 provides exemplary steps for spray drying and it will be appreciated that these steps can also be used with the methods of FIG. 1. It will be appreciated that if the cultured dairy component is further processed by concentration, spray drying or the like, this further processing will be completed in a manner to not substantially affect the nisin and/or EPS.

The cultured dairy component produced by the methods of FIGS. 1 and 2 with both antimicrobials and EPS produced from the same bacterial strain may then be used in and/or to manufacture processed cheese. In one approach, the processed cheese may be produced by blending together natural cheese or mixture of natural cheeses, moisture, and a an optional additional dairy protein source (such as milk protein concentrate, whey, whey protein concentrate, ultra-filtered milk, and the like) and the cultured dairy component. Sodium chloride may be added for flavor. Other optional ingredients may be added to improve texture, flavor, nutrition, and/or cost attributes. These include, but are not limited to, whey derived ingredients (e.g., whey protein concentrate), non-fat dry milk, milk protein concentrate, anhydrous milk fat, gums, starches, gelatin, and the like. The ingredients are blended together and then heated to pasteurization temperatures. Optionally, shear may be applied during or after the heating.

Whey protein refers to a collection of globular proteins that can be isolated from whey, which is the liquid remaining after milk has been curdled and strained. Whey protein is typically a mixture of beta-lactoglobulin, alpha-lactalbumin, and serum albumin proteins. In one embodiment, whey protein concentrate (WPC) may be used as the whey protein source. WPC is derived from whey by conventional concentration techniques. The whey protein source may also include lactose, vitamins, minerals, and fat.

Moisture may be added to the blend by any method, such as, but not limited to, injecting steam into the cooker (e.g., a laydown cooker), comingling of condensed steam from cooking, and/or direct addition of water. Of course, moisture can also enter into the system through the various ingredients (e.g., moisture from the natural cheese). Overall moisture of the final cheese products includes all moisture independent of how the moisture was introduced into the final product. Advantageously, because the cultured dairy components of the present disclosure, in some forms, are concentrated dairy components that include both nisin and EPS at the same time, water management of the processed cheese is improved. To this end, because nisin and other texture modifying ingredients do not need to be separately added, less water tends to be added into the processed cheese via the cultured dairy component ingredient.

As is known by one of ordinary skill in the art, the ingredients may be used in varying amounts in the processed cheese depending on the desired outcome of the cheese product. For example, for a reduced sodium cheese product, a cheesemaker may include a small amount or no salt in the cheese blend. The processed cheese may also include a range of amounts of the cultured dairy components, depending on the form and composition of the cultured dairy components and the desired form of the processed cheese.

For example and in one form, the processed cheese may include about 10 to about 90% natural cheese. According to another form, the processed cheese may include about 30 to about 60% natural cheese. In yet another form, the processed cheeses herein may include about 35 to about 55% natural cheese. As used herein, natural cheese generally means cheese provided from unpasteurized cheese obtained from curdled milk and one of rennet, rennet substitutes, acidification, and combinations thereof.

The processed cheese may also include a number of other dairy ingredients from various sources as needed for a particular application. For example and in one form, the processed cheese may include milk protein concentrate from about 0 to about 50% (in other approaches, about 10 to about 25%), whey protein concentrate from about 0 to about 25% (in other approaches, about 1 to about 10%), whey from about 0 to about 30% (in other approaches, about 1 to about 10%), milkfat/cream from about 0 to about 30% (in other approaches, about 1 to about 15%) and the like. The processed cheese may also include emulsifiers, such as sodium citrate, disodium phosphate and the like in an amount of about 0% to about 5% (in other approaches, about 1 to about 3%). The processed cheese may also include salt, flavorings, fortifications, colorants and the like to provide the desired color, flavor, etc. The processed cheese may also include added water and/or moisture from the ingredients to provide the desired finished product moisture. For example, vitamins and other minerals may also be added as needed to fortify the processed cheese, by one approach, from about 0 to about 3 percent of vitamin A, vitamin D and/or calcium powders (such as tricalcium phosphate). In other applications, salt may also be added as needed. In some approaches, about 0 to about 5 percent salt may be added.

Furthermore, instead of traditional preservatives, the processed cheese may include the cultured dairy component of the present disclosure and made via the methods described herein. In one form, the processed cheese may include about 1 to about 20% cultured dairy component. In another form, the processed cheese includes about 4 to about 10% cultured dairy component. In some approaches, the cultured dairy components of the present disclosure provide a much higher total antimicrobial activity as nisin equivalent relative to the nisin content (a nisin activity ratio). For instance and in some approaches, the cultured dairy components and processed cheese utilizing the amounts of cultured dairy components described herein exhibit a nisin activity ratio of about 0.3 or less.

It should be noted that the cultured dairy components may be used as a replacement for artificial preservatives and/or may also be used to partially supplement or replace other components in the overall processed cheese composition. For example, depending on the form of the cultured dairy component, the amount of the cultured dairy component may be used to supplement or otherwise replace a portion of the other dairy materials in the composition, such as the milk fat, casein, whey and the like. In other words, the ratio of the other dairy materials may be modified as a result of the use of the cultured dairy components. When the processed cheeses include the cultured dairy components herein, the cheese may be substantially free of traditional preservatives, such as sorbic acid, nitrites and the like. By one approach, substantially free of generally means less than about 0.5 percent, in other approaches, less than about 0.1 percent, and in other approaches, not present at all.

In one form, the processed cheese includes about 40% natural cheese, 35% other dairy materials, about 8% cultured dairy components, about 12% water and the remainder salts, flavoring, colors, vitamins, minerals and the like. The processed cheese may be manufactured as generally understood with the addition of the cultured dairy components during cooking, and alternatively, during cheese blending steps. In one form, the cheese product described herein may be any of a cheese dip, a cheese spread, a cheese block, a cheese slice, a shredded cheese, or the like. In some approaches, the various forms of processed cheese of the present disclosure may include about 10 to about 90% natural cheese, about 0 to about 50% milk protein concentrate, about 0 to about 30% milk fat or cream, about 40 to about 60% water, about 1 to about 20% cultured dairy component,, about 0 to about 30% whey, and about 0 to about 25% whey protein concentrate in combination with various optional flavors, salts, and emulsifiers described above.

In another form, the processed cheese includes about 10 to about 30% total fat (in other approaches, about 20 to about 30% fat), about 8 to about 25% total protein (in other approaches, about 15 to about 25% total protein), and about 40 to about 60% total moisture (in other approaches, about 40 to about 50% moisture).

Not only does the processed cheese made with the cultured dairy components of the present disclosure exhibit unexpected benefits of texture because it achieves an improved melt profile and increased firmness at the same time, the processed cheese made with the cultured dairy components of the present disclosure also exhibits improved antimicrobial characteristics in the context of a high protein and high fat product, such as a processed cheese with about 10 to about 30% fat and about 8 to about 25% protein. While prior commercial forms of nisin were commonly understood to inhibit C. botulinum in liquid media or broth, when such prior forms of nisin were used in a high-protein and high-fat food systems, such as processed cheese, the nisin was less effective at inhibiting the C. botulinum and other pathogens. While not wishing to be limited by theory, it is believed that the high protein, high fat, and in some case, the lower moisture level of the processed cheeses described herein, tend to protect and/or encapsulate the C. botulinum and other pathogens rendering traditional nisin and traditional natural antimicrobials less effective. It was unexpectedly discovered that the nisin obtained from the antimicrobial cultures herein, and in particular, strain 329, are effective to inhibit C. botulinum and other food-borne pathogens such as Listeria monocytogenes, in the context of high fat and high protein processed cheese much better than other forms of nisin as generally shown below in Example 1. In some approaches, the cultured dairy component in processed cheese provides an amount of nisin effective to prevent toxin formation from at least C. botulinum as determined by conventional toxin bioassay with mice in the processed cheese at the high protein and the high fat levels described herein for at least about 9 to about 10 days at about 86° F. In one approach, the biotoxin assay may be performed in accordance with Haim M. Solomon et al., Bacteriological Analytical Manual, Chapter 17, Clostridium botulinum, January 2001, available at http://www.fda.gov/Food/FoodScienceResearch/LaboratoryMethods/ucm070879.htm, which is hereby incorporated by reference in its entirety.

Not only do the cultured dairy components of the present disclosure inhibit C. botulinum and other pathogens in the context of a high protein and high fat processed cheese, the cultured dairy components achieve such inhibitory effects at lower activity levels and/or lower dosage levels than previously found possible.

In other approaches, liquid forms of the cultured dairy components herein or made by the processes herein retain higher levels of nisin activity in the final processed cheese, which was not achievable using prior commercial forms of nisin when used in processed cheeses. By one approach, the cultured dairy ingredients described herein and made by the methods described herein are effective to retain about 50 to about 90 percent activity, and in other approaches, about 60 to about 75 percent activity as compared to the activity of the ingredient prior to incorporation into the processed cheese.

In some approaches, the cultured dairy component is made using an ultrafiltered dairy liquid either before or after fermentation. In these approaches, the cultured dairy component has reduced levels of lactose and other dairy minerals. For example and in some approaches, the cultured dairy component and the processed cheese utilizing the cultured dairy component may have less than about 0.1 percent lactose and less than about 15 percent lactate as acid. In other approaches, the cultured dairy component and the processed cheese utilizing the cultured dairy component may also have less than about 600 mg/100 grams of calcium.

Advantages and embodiments of the compositions, methods, and compositions produces by the methods described herein are further illustrated by the following examples; however, the particular conditions, processing schemes, materials, and amounts thereof recited in these examples, as well as other conditions and details, should not be construed to unduly limit this method. All percentages and ratios within this disclosure are by weight unless otherwise indicated.

### EXAMPLES

The following examples illustrate the performance of processed cheese slices prepared with cultured dairy components as described above and control samples of process cheese without the cultured dairy component but, instead, using sorbic acid as the preservative. The samples were generally prepared as processed cheese slices having about about 46 percent moisture, about 23 percent fat, about 1.2 percent salt, and about 18 percent protein with varying amounts of preservatives and/or cultured dairy components (where indicated), flavors, colors, vitamins, minerals and the like.

### Example 1

Processed cheese slices were prepared utilizing liquid cultured dairy component with 28% solids as described herein from strain 329 and compared to processed cheese slices prepared with cultured spray-dried whey. The cultured spray-dried whey was in a powdered form having approximately 96% solids with essentially no fat and little protein. Both the commercial, cultured spray-dried whey and the liquid cultured dairy component made according to the process of FIG. 1 and utilizing strain 329 were used in a processed cheese. Table 4 below illustrates that the processed cheese prepared with cultured dairy components from strain 329 retained significantly more antimicrobial activity when compared to commercially available antimicrobial materials. This activity retention effect was seen for both the 6% and 8% loading of the cultured dairy components in processed cheese. In this regard, as the cultured dairy components retain antimicrobial activity much better than the commercially available microbial, the antimicrobial effect may last longer and otherwise require lower dosing for the same efficacy.

TABLE 4
Activity retention of antimicrobials in processed cheese

| | | | | Activity | |
|---|---|---|---|---|---|
| | Ingre- | % Usage | | Level in | |
| | dient | in | Dosage | processed | % |
| | Activity | Processed | Level | cheese slice, | Reten- |
| Antimicrobial | AU/g | Cheese | AU/g | AU/g | tion |
| Comparative, | 20,000 | 1% | 200 | 90 | 45% |
| spray dried | | | | | |
| cultured whey | | | | | |
| Comparative, | 20,000 | 2% | 400 | 130 | 32.5% |
| spray dried | | | | | |
| cultured whey | | | | | |
| Liquid, cultured | 2220 | 6% | 133.2 | 90 | 67.6% |
| dairy component | | | | | |
| of the present | | | | | |
| disclosure | | | | | |
| Liquid, cultured | 2220 | 8% | 177.6 | 150 | 84.5 |
| dairy component | | | | | |
| of the present | | | | | |
| disclosure | | | | | |

Another comparison was made where a liquid cultured dairy component prepared from powders and combined with liquid water according to the method of FIG. 2 having about 20% total solids were prepared. In this comparison, a commercially available nisin source (Nisaplin, Danisco) and a spray dried cultured whey powder were each included in processed cheese and compared to a similar processed cheese made with the cultured dairy component of the present disclosure. As shown in Table 5 below, when 8% of the cultured dairy component made from strain 329 in accordance with the present disclosure was used in processed cheese slices, no toxin (C. botulinum) was detected after about 10 days whereas similar processed cheese prepared with commercially available antimicrobials (either Nisaplin or spray dried cultured whey) had toxins present on about days 7 and 10. The toxin challenge study was performed by Silliker Laboratory. Other conventional methodologies for toxin challenge studies may also be used, if desired.

TABLE 5
C. botulinum Challenge Study

| | % Usage | Measured | Key Results |
|---|---|---|---|
| | in | AU in | of CBOT |
| | Processed | Finished | Challenge |
| Antimicrobial | Cheese | Product | Study |
| Comparative, Commercially | 0.023% | 210 AU | Toxin present |
| available nisin (Nisaplin) | | | at day 10 |
| Comparative, Spray dried | 1% | 90 AU | Toxin positive |
| cultured whey | | | on day 7@ |
| | | | 86° F. |
| Cultured dairy component | 8% | 70 AU | No toxin |
| of present disclosure (20% | | | present |
| total solids, liquid) | | | at day 10 |

### Example 2

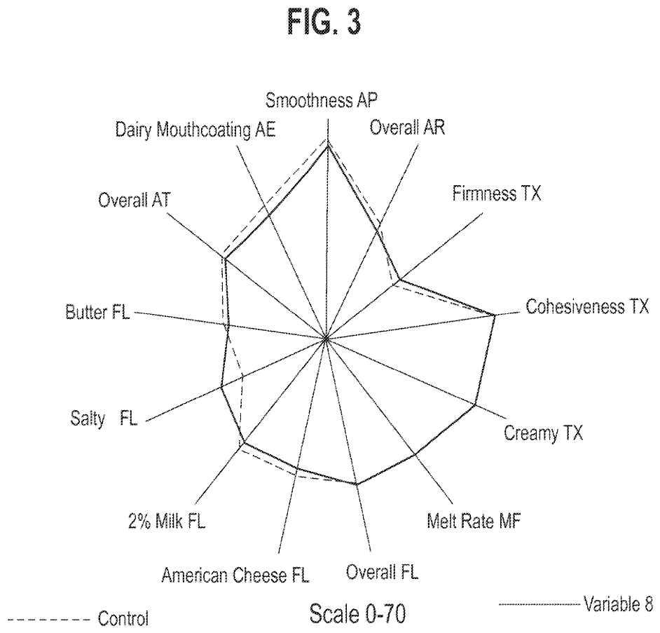

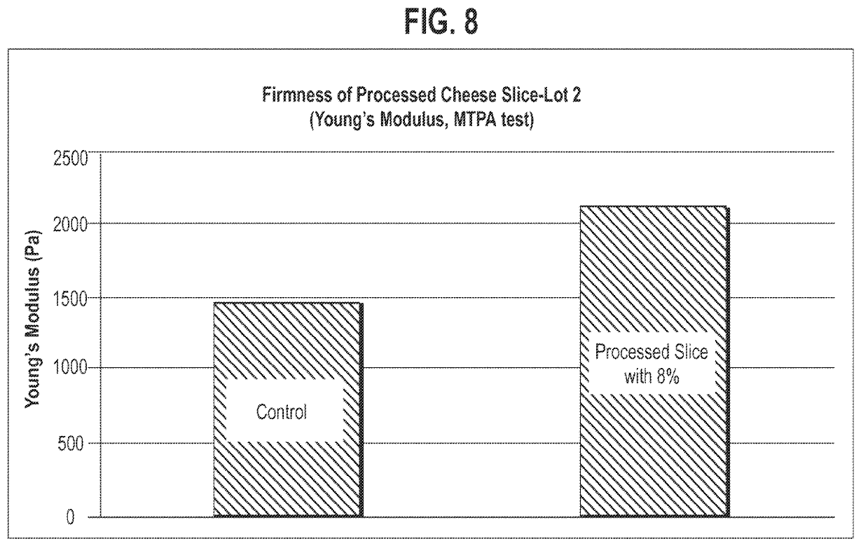

Flavor comparisons were performed on samples of processed cheese slices as shown in FIG. 3. Processed cheese samples were prepared with about 0.2 percent sorbic acid as a preservative (identified as “control”) or without sorbic acid and about 8% cultured dairy component prepared according to the present disclosure and utilizing strain 329 (identified as “variable 8”) and tasted and evaluated by a trained sensory panel. As shown in FIG. 8 (which summarizes the taste perception in the mouth of the trained panel), processed cheese prepared with the cultured dairy components of the present disclosure generally had the same taste perception profile as processed cheese prepared with sorbic acid as a preservative. Therefore, it is expected that it would be acceptable, from a flavor perception aspect, to replace sorbic acid as a preservative with cultured dairy components.

### Example 3

Numerous processed cheese samples were prepared to compare the melt profiles of processed cheese slices prepared with and without the cultured dairy components obtained from strain 329 of the present application. The samples include about 2% to about 8% cultured dairy components and were compared to control samples without the cultured dairy components. The fat, moisture, protein, and pH of the cheese was held relatively constant between all the test samples (about 43 to about 44 percent moisture and about 5.7 pH). The control samples without the cultured dairy component contained 0.18% sorbic acid as a preservative or, in some cases, were free of sorbic acid in order to rule out that the melt was due to the lack of sorbic acid. In this Example, the samples made with the cultured dairy component increased in melt diameter. The others did not. This is shown by the date in tables 6, 7, and 8 below.

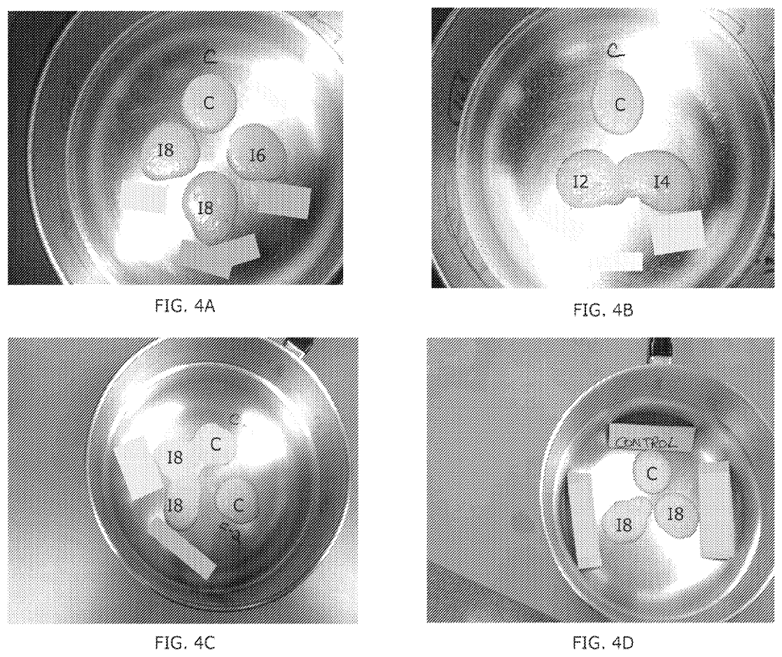

Each test sample included 3 circular slices of processed cheese stacked on top of one another. The samples were placed on top of a double boiler and heated with boiling water on medium heat for approximately 4 minutes. As shown in FIGS. 4A-4D and 5A-5C, the samples prepared with cultured dairy components had increased surface area when melted as compared to the control samples without the cultured dairy components of the present application. As shown in FIG. 5C, the melt diameter of the control cheese was about 1.125 inches while the melt diameter of the inventive samples with about 6 percent of the cultured dairy component were about 1.6 and about 1.45 inches. In these figures, controls samples are labeled “C” and inventive samples are labeled 12, 14, 16, or 18 representing inventive processed cheese disks with either about 2 percent, 4 percent, 6 percent or 8 percent cultured dairy component made with strain 329.

Surface area measurements were completed to measure the melt profiles of the samples. Tables 6, 7, and 8 to below illustrate calculated surface areas using ImageJ software (a public domain, Java-based image processing program, National Institute of Health) for some of the samples corresponding to those shown in FIGS. 4A-4D and 5A-5C. As shown in the tables, processed cheese samples prepared with the cultured dairy components of the present application at 4%, 6% and 8% in processed cheese all showed increased surface area upon melting compared to the controls without cultured dairy components. Generally, consumers prefer processed cheese with increased melt performance such as shown by the samples with cultured dairy components.

TABLE 6
Surface Area Measurements

| | Surface Area | Surface Area |
|---|---|---|
| Sample | (square pixels) | (square pixels) |
| Control Lot | 89088 | 189300 |
| 8% cultured dairy component | 139149 | 326995 |
| % Area Increase w/cultured | 56.19% | 72.74% |
| dairy component | | |

TABLE 7
Surface Area Measurement

| | Surface Area | % Area Increase with |
|---|---|---|
| Sample | (square pixels) | Cultured Dairy Component |
| Control Lot | 167488 | n/a |
| 4% liquid cultured | 211365 | 26.20% |
| dairy component | | |
| 4% cultured dairy | 223930 | 33.70% |
| component powder | | |

Based on the data above, the samples including the cultured dairy component of the present disclosure resulted in wider disc melts than the control samples without the cultured dairy component.

TABLE 8
Surface Area Measurement

| | Surface Area | % Area Increase with |
|---|---|---|
| Sample | (square pixels) | Cultured Dairy Component |
| Control Lot | 179171 | n/a |
| 6% liquid cultured | 233075 | 30.09% |
| dairy component | | |
| 6% cultured dairy | 248472 | 36.68% |
| component powder | | |

### Example 4

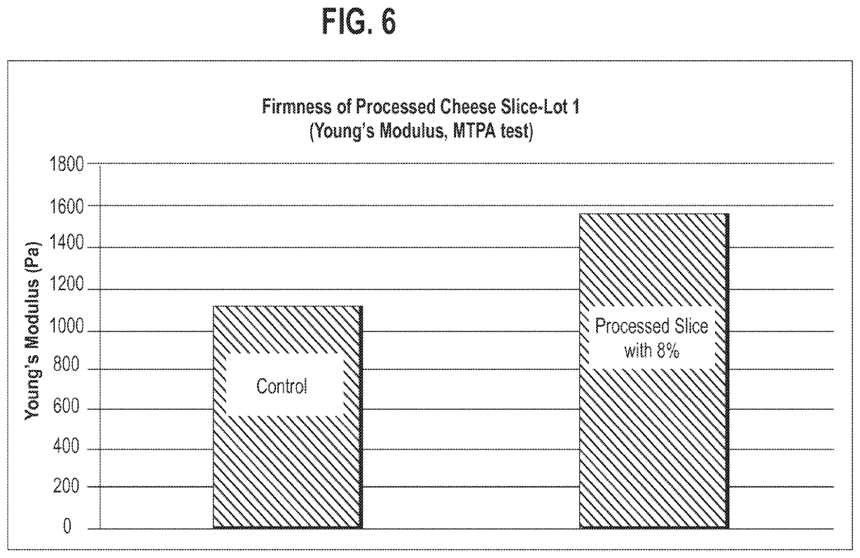

FIGS. 6-9 illustrate firmness and consistency comparisons between processed cheese slices made with cultured dairy components made by the methods of the present application using strain 329 and without cultured dairy components (control). In this Example, the solids, protein, fat, and moisture were held relatively constant across all samples tested. The samples without the cultured dairy component included 0.18 sorbic acid as a preservative and, in some cases, did not contain sorbic acid or any preservatives so as to rule out the firmness was due to the lack of sorbic acid. In this Example, only the samples with the cultured dairy component increased in firmness and consistency.

As shown in FIGS. 6 and 8, the processed cheese with cultured dairy components showed increased firmness (i.e., Young's modulus) compared to the control samples made without cultured dairy components. Generally, this increased firmness suggests a more natural cheese composition to consumers. Young's modulus, which is also known as the tensile modulus, is a measure of the stiffness of a material. In the context of a processed cheese, Young's modulus is a measurement of the initial touch of the cheese slice. In the context of this Example, initial touch means the resistance that the cheese provides when it is touched with a finger or hand. It is another measurement of the perception of firmness. Young's Modulus was measured using a texture profile analysis (MTPA) using a texture analysis machine (Texture Technologies Corp) that measures the amount of force needed to penetrate a stack of cheese slices when a known weight is applied. For this test, about ten 21 gram slices of cheese are stacked together. Generally, Young's modulus is calculated by dividing the tensile stress by the tensile strain in the material and represents the ratio of stress (load) to the strain (deformation) in the initial Hookean region. This typically represents how stiff or firm a sample is in response to an external load. Further, a product having a higher consistency value should provide a more chewy sensory perception.

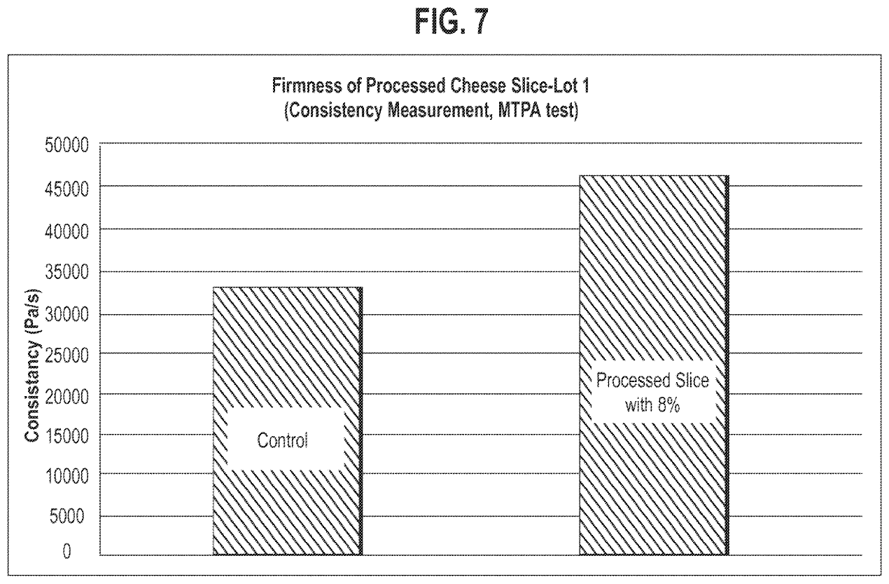

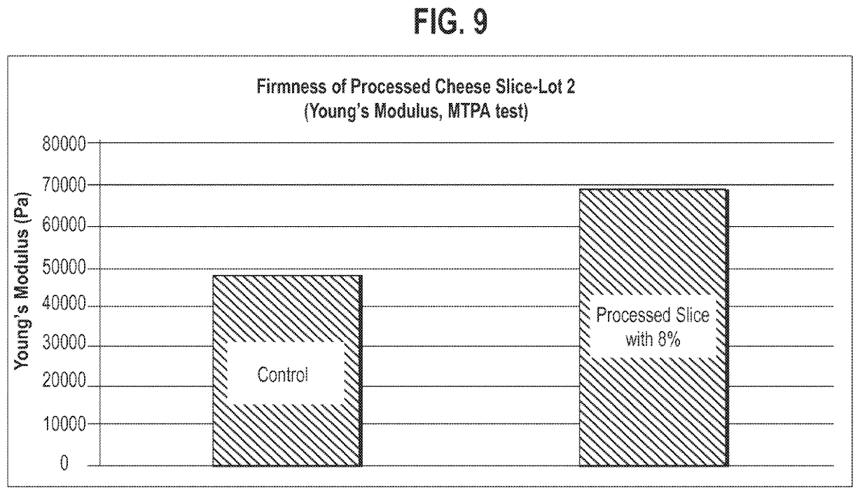

Further, FIGS. 7 and 9 illustrate the consistency of the processed cheese samples via the firmness during flow of the cheese while the force is being applied during the MPTA test. As shown in FIGS. 7 and 9, the processed cheese with cultured dairy components showed increased consistency during flow compared to the samples without cultured dairy components. Generally, this increased firmness during flow also suggests a more natural cheese composition to consumers. As used herein, consistency is generally related to the firmness during flow or resistance to flow. In the context of processed cheese, the higher the consistency value, then the cheese exhibits a slower rate of breakdown in the mouth, which is generally perceived as a desirable characteristic to consumers.

As shown above, processed cheese compositions prepared with cultured dairy components of the present disclosure and made from strain 329 are capable of providing at least equivalent, if not improved, antibacterial properties and preservative functionality. Further, it has been unexpectedly found that processed cheese prepared with these cultured dairy components exhibit improved melt and, at the same time, increased firmness of the processed cheese. Generally, it was previously expected that when cheese melt increases, the firmness decreases. It is believed that the materials generated in the cultured dairy component by strain 329 unexpectedly help to improve both properties of the cheese at the same time.

### Example 5

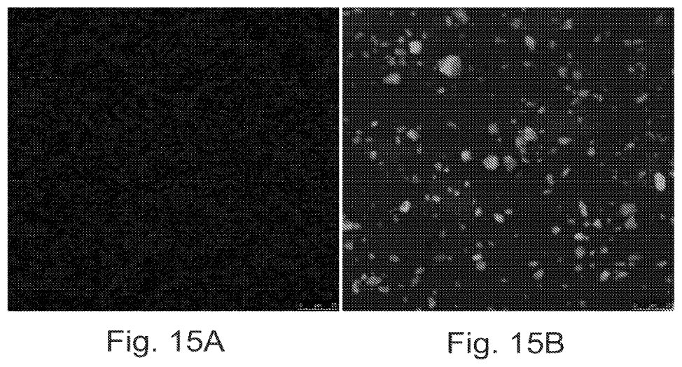

3× milk (pH 5.46) was used as the liquid media for fermentation of cultured dairy components. A sample of the 3× milk was taken prior to inoculation with L. lactis strain 329. The cultured dairy components were prepared according to the process of FIG. 1 with an approximately 21 hour fermentation. A further sample was taken after fermentation (pH 5.46). The samples were then stained using Alexa Fluor® 488 conjugate of Concavalin A, which selectively binds to α-mannopyranosyl and α-glucopyranosyl residues, to determine if exopolysaccharides were produced during fermentation. The ConA Alexa Fluor 488 was solubilized in 0.1 M phosphate buffer at pH 6.8 and diluted with whey permeate to pH 6. Drops of staining solution were applied to the samples onto a chambered glass slide and left for 30minutes at 25° C. The slides were then covered with a glass coverslip and observed with a Leica SP5 confocal scanning laser microscope (CSLM) with a 20× objective with 495 nm (excitation) and 519 nm (emission) wavelengths. As shown in FIGS. 15A and 15B (scale bar 25 μm), exopolysaccharide (EPS) was observed in the fermented sample but not in the 3× milk starting material prior to inoculation with strain 329. EPS was observed as a large aggregated mass.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1-20. (canceled)

21. A cheese product including natural antimicrobials, the cheese product comprising:
one or more emulsifiers;
about 8 to about 25 percent protein;
about 10 to about 30 percent fat;
about 40 to about 60 percent moisture;
an amount of nisin, effective to prevent toxin formation from C. botulinum determined by toxin bioassay with mice, in the cheese product at the protein and the fat levels thereof for about 9 days at 86° F.; and
an amount of exopolysaccharide,
wherein the nisin and exopolysaccharide are included in the cheese product in the form of a cultured component,
the nisin and the exopolysaccharide in the cultured component are obtained from a fermentation of a single lactic acid producing Lactococcus lactis strain in a concentrated liquid medium, and
the cultured component is effective to increase the melt and firmness of the cheese product relative to a cheese product without the cultured component.

22. The cheese product of claim 21, wherein the cheese product includes about 1 to about 100 ppm of nisin and about 100 to about 2,000 ppm of exopolysaccharide.

23. The cheese product of claim 21, wherein the cheese product includes about 1 to about 20 percent of the cultured component.

24. The cheese product of claim 21, wherein the Lactococcus lactis strain is an isolated Lactococcus lactis strain having all of the identifying characteristics of the Lactococcus lactis strain of ATCC PTA-120552.

25. The cheese product of claim 24, wherein the fermentation of the Lactococcus lactis strain ATCC PTA-120552 is conducted in a 3× to a 5× concentrated liquid medium at a temperature of about 25 to about 35° C. and a pH of about 5 to about 6 for about 15 to about 48 hours.

26. The cheese product of claim 25, wherein the concentrated liquid medium is a concentrated milk having a total solids of about 5 to about 36 percent, about 1 to about 14 percent protein, and about 0 to about 16 percent fat.

27. The cheese product of claim 21, wherein the cheese product is free of artificial preservatives selected from the group consisting of sorbic acid, potassium sorbate, nitrites, and mixtures thereof.

28. The cheese product of claim 21, wherein the nisin is nisin A.

29. The cheese product of claim 21, wherein the cheese product includes nisin A and at least one gene from a nisin producing gene cluster with significant homology to the sequences selected from the group consisting of SEQ ID NOS 9 to 19 and at least one gene from an exopolysaccharide producing gene cluster with significant homology to the sequences selected from the group consisting of SEQ ID NOS 21 to 33.

30. The cheese product of claim 29, wherein the at least one gene from a nisin producing gene cluster and the at least one gene from the exopolysaccharide producing gene cluster are from the same Lactococcus lactis strain.

31. The cheese product of claim 30, wherein the Lactococcus lactis strain is an isolated Lactococcus lactis strain having all of the identifying characteristics of Lactococcus lactis strain ATCC PTA-120552.

32. The cheese product of claim 21, wherein the cheese product exhibits a firmness of about 1500 to about 2500 Pa.

33. The cheese product of claim 21, wherein the cheese product exhibits a consistency of about 50,000 to about 70,000 Pa/second.

34. The cheese product of claim 21, wherein the cheese product exhibits an increase in melt of about 20 to about 75 percent compared to a cheese product that does not include the cultured component.

35. The cheese product of claim 21, wherein the cultured component is effective to achieve a nisin activity ratio of about 0.3 percent or less in the cheese product.


SEQUENCE LISTING (33 sequences)

SEQ ID NO: 1 - protein, 34 aa, Lactococcus lactis
  SITE 2: note = MISC_FEATURE - Dehydrobutyrine (beta-methyldehydroalanine)
  CROSSLNK 3..7: note = THIOETH -
  SITE 5: note = MISC_FEATURE - Dehydroalanine
  CROSSLNK 8..11: note = THIOETH -
  SITE 8: note = MISC_FEATURE - Amino butyric acid
  CROSSLNK 13..19: note = THIOETH -
  SITE 13: note = MISC_FEATURE - Amino butyric acid
  CROSSLNK 23..26: note = THIOETH -
  SITE 23: note = MISC_FEATURE - Amino butyric acid
  CROSSLNK 25..28: note = THIOETH -
  SITE 25: note = MISC_FEATURE - Amino butyric acid
  SITE 33: note = MISC_FEATURE - Dehydroalanine
IXAIXLAXPGAKXGALMGANMKXAXAHASIHVXK

SEQ ID NO: 2 - DNA, 1086 bp, Lactococcus lactis
  source 1..1086: mol_type = genomic DNA
atgaaacagaaacataaattagcgcttggtgcgtcaattgttgctttggcaagtcttggtgggattaaagcacaagctgcatctgttcaagaaattattaacgctgcggtaccagtggcaaatgactacggactttatccatcagtaatgattgcccaagggattttagaatcaagtggtggacaaagtgccttagcaagcaattataataatatttttggagttaaatacacttctggtacacctgtttatctaccaacacaagagtatttgaatggaacaatgacaaatgttgttgaacccttccaagcttatagctcagtttatgacgcatgtgttgcccaagctaaaatgttacgtgcttcatcatattattctggggcttggcgtgaaaatacaagttcttacttagatgcgacagcttggcttgaaggacgttatgccacggatccaacttatgcttctaaattgaatagcgtgatttctgaacttggtttaagtgtttatgaccaaggaggagaaatatcaggaggaactgctgttacaactagttcatcagcctcaacaaattcagctggcacatacaaagtacaagagggtgattcattatcagcaatcgctgctcaatatggtacaactgttgatgcacttgtgtcagcaaatagtttagaaaatgcgaacgatattcatgtaggagaagttttgcaagttgctggtgctagcacaactacaacaagtaccaatacaacttccaatgtatcgtcaagttctacttataccgtcaaatcaggagatagtttatattcgattgcggaacaatatggaatgactgtttcatcactgatgtcagccaatggaatttatgatgttaattcaatgcttcaagtaggacaagtattgcaagtaactgtaagtactagtgcaacaacttcaaacacaacgacttcaaacagttatacaattcaaaatggtgacagcatttattcaattgccacagcaaatggtatgacagctgaccaattagcagccctcaatggatttggaattaatgacatgattcatccaggacaaacaattagaatctaa

SEQ ID NO: 3 - DNA, 1011 bp, Lactococcus lactis
  source 1..1011: mol_type = genomic DNA
atggtagttaaagttggtattaacggtttcggtcgtatcggtcgtcttgctttccgtcgtattcaaaatgttgaaggtgttgaagttgttgcaatcaacgacttgacagatccagcaatgcttgctcacttgcttaaatacgatacaactcaaggtcgttttgatggtaaagttgaagttaaagatggtggttttgaagttaacggtaaattcgttaaagttactgctgaatctaacccagctaacatcaactgggctgaagttggtgcagaaatcgttcttgaagcaactggtttcttcgcaactaaagaaaaagctgaacaacacttgcacgctaacggtgctaaaaaagttgttatcactgcacctggtggatctgatgttaaaacaatcgttttcaacactaaccacgaagtacttgatggaactgaaacagtaatttcagctggttcatgtacaactaactgtcttgctccaatggctgatactttgaacaaacaattcggtatcaaagttggtacaatgactacagttcacggttacactggtgaccaaatgactcttgatggcccacaccgtggtggagacttccgtcgcgcacgtgctgcagctgaaaacatcgtacctaactcaacaggtgctgctaaagctatcggtcttgtattgccagaacttcaaggtaaacttcaaggacatgctcaacgtgtaccagttccaactggttcattgactgaacttgttactatccttaacaaagaagttacagttgacgaaatcaacgcagctatgaaagctgcttcaaatgaatcatttggttacaacgaagaccaaatcgtttcatctgatatcgttggtatctcaaactcttcactctttgatgctactcaaactgaagttacttcagctgatggagctcaacttgttaaaactgtatcttggtacgataacgaaatgtcatacacttcaaaccttgttcgtacacttgcatacttcgctaaaatcgctaaataa

SEQ ID NO: 4 - DNA, 1419 bp, Lactococcus lactis
  source 1..1419: mol_type = genomic DNA
atggttgttggtgcacaagcaacagaagttgatttggttgttattggttcaggccctggtggttatgttgcagccatccgtgcggctgaacttggtaaaaaagttacaattattgaaaaagataatgttggtggggtttgtttaaatattggttgtatcccatcaaaagcattgattaatattggtcatcattaccaagaatctttggaggaagaaaaaggagaaaatccttttggtctttctgtcggaaatgttaaattaaactgggaatctgcccaaaaatggaaacaagataaagttgtcaaccagttgacaggtggtgttaaaatgctacttaaaaaacacaaagttgacgtgattcaaggaactgcagaatttattgataacaatacaataaatgttgaacaagaagatgggttccaacttttgcaatttaatgatgtgattatctcaactggttcacgtcctatcgaaattccttctttcccatttggtggtcgcattattgactctactggtgctttgtcacttccagaagttcctaaacatttgattattgttgggggaggagttattggttctgagcttggtggagcataccgtatgctcggttctaagattacaattgttgaaggtttggaccacattttaaacgggtttgataaagaaatgtctgatatcattgctaatcgcgttaaatctgctggttctgaaatctttacttcagcaatggctaaatcagctactcaaactgataaagatgtaactttgacttttgaggttgacggaaaagaacaaacggtgactggtgattacttactcgtttctgttggacgtcgtccaaatactgatttaatcggcttgaacaacactgatgttaaattgactgaccgtggtttgattgaagttgacgattcttatgcaactaatgttcctcacatttatgcaatcggtgatgtggttcctggtccaatgctcgctcacaaagcttctttccaagctaaagttgctgctgctgcgattgctggagctgaggacgacgtggacttacacgttgctttgcctgctgtagcttatacaacaactgaattagcaacagttggagaaacgcctgaatcagttaaagaccgtaaagatgttaaaatttctaagttcccatttgctgcaaatggccgtgccatttcaatgaatgatacgactggtttcttacgtttgattactgaaactaaagaaggggccttaatcggtgctcaaatcgttggccctggtgcatctgacttgatttctggtttatcactagcgattgaaaatggattgacttctaaagacatttcattgactatccaacctcacccaacacttggtgaagcgattatggatacagctgaattggctgatggcttaccaattcacgtttaa

SEQ ID NO: 5 - DNA, 1311 bp, Lactococcus lactis
  source 1..1311: mol_type = genomic DNA
atgacagtaacatcagatttcacacaaaaactctacgaaaattttgcagaaaatacaaaattgcgtgcggtggaaaatgccgtgactaaaaatggtttgctttcatcactcgaagtccgtggttcacatgcagcaaatttgcctgagttttcaattgacttgacaaaagaccctgtaacgaatcaaaaacaatctggtcgttgctggatgtttgctgctttgaacactttccgtcataaatttatcaatgaatttaaaacagaggattttgagttttcacaagcttacactttcttctgggataaatatgaaaaatcaaactggttcatggaacaaattattggtgatattgaaatggacgatcgtcgtttgaaattccttttacaaacaccacaacaagatggcggccaatgggatatgatggttgcaatttttgaaaaatatggaattgttcccaaagctgtttatcctgaatcacaagcttcaagtagctcacgtgaattgaatcaatacttgaataaactactccgtcaagatgctgaaattttgcgttatacaattgagcaaggtggagatgttgaagcagttaaagaagaacttttgcaagaagtctttaatttccttgcggtaactttaggtttgccaccacaaaattttgaatttgctttccgtaataaagataatgaatacaaaaaatttgttggtagtccaaaagaattttacaatgaatatgttggaattgatttgaataattatgtgtcagtaatcaatgctccaactgctgacaaaccttataataagagctacacagttgagtttcttggaaatgttgtcggtggtaaagaagtgaaacatttgaatgttgaaatggaccgctttaaaaaattggccattgcccaaatgcaagctggtgaaacagtttggtttggttgtgacgtgggtcaagaatcaaatcgttcagcaggacttttgacaatggattcttatgatttcaaatcttcattggatattgaatttactcaaagcaaagcaggacgtcttgactatggtgagtcgttgatgacgcatgccatggttttagcgggtgttgatttagatgctgacggaaattcaactaaatggaaagttgaaaattcatggggtaaagatgcgggtcaaaaaggatattttgttgcctctgatgaatggatggatgaatatacttatcaaattgttgtccgtaaagaccttttaactgaagaagaattggctgcttacgaagagaaacctcaagtacttctaccatgggacccaatgggtgctttagcttaa

SEQ ID NO: 6 - DNA, 648 bp, Lactococcus lactis
  source 1..648: mol_type = genomic DNA
atgaaaaataaaattttagacctgagggcatattttattgctggcccacaagattttccaaaactttcaattgatgatgcaatcgataaaatttctgtaatcataaaaagtggagtaacggtttatcaatttcgtgataagggaacaatttataaaaataaaaatcaacgattagaagtagcaaaaagactacaagaagtagctcagaaagcggctgtttcttttattgtgaatgatgatgttgaattagcgcgtgaattgtcagctgacgggattcatgtcggacaagacgatgattctgtcagtaaaattcgtgagctgattggccaagaaatgtgggtaggactttctgtcagtaatgatatggaattagaaagcgctcaaaagagtggggctgactatttgggaattggtccaatttatccaacaaatagcaagtccgacgcagcagaaccaattggggttgaccatttaagaaaaatgcttgagcataatcaattaccaactgttggaattggtggaattactgaaaattcactgacagagctttcaaaaattggtctgggtggagttgcggtaatttctttgctgacagaatccgaaaattacaaaaatatggttcaaaaaattaagcaaaatattagatga

SEQ ID NO: 7 - DNA, 1623 bp, Lactococcus lactis
  source 1..1623: mol_type = genomic DNA
atgaaacaaccactttataatacaggagttttatttaagactttaataaaaagggattggtttaagttagttttctggattttaggaatgcttgcttttgctgcttcaggggcagggaaaatggaagttgcctcgaatccggcgacggctagtactctttatacaatgtttgtcaaaaatccagcaatggtcggattatttggaccaactccaataaataatccaactaattatagtctggggccgatttttggtcaaaccatgactttaattacggggctgactttcgctatcatttcgattatttatgttgttaatcgaagcagaaaagaagaagatgatgggattacagaactttttcggtcttactctattggaaaattggcaaatacgactgctttagtcatggaacttttgctcttaaatttaataatggctgtcttattagctctttcaatagaggtccaaaacgtggctggcttgaatcatttagaaagtaattttctatttgctttcacaacaagcgctcagggtttcctttggggaatgtttgctttacttttcggtcaaattttctctgaagcaagtacaactaaagggatgacatttggtttactgggtttgttatatattgttcgaatgctaacagatgtaacaaatctttccataggttggttcaatcctctgtcttggtcttatctagcttttccatatgttaaaggtcatgaaaattggttagctgtctttttgacttttctcttagcttttctaattttaggaatatcctatattctagagcttaaaagagatgtgggagtggggtattttcccgaaagaaaggcgcgacttcatgggaaaaagggacatttcggatttcctggtctcgttttgaatcttgaaaaaaagatgattatcggttggcttttggcaagttttgttctgggcttagtttatggttcaatgtttggacaaatggaccaatttatttcaagtaataaaaccgttaaggagctttttgttgggaatgaaacggcagcgagtgcgattagaggaaacttcatggtcactctgttttcgatattgtcaatcttaatcgcagcgtttggtgtaattttactgacaaaaatggtgagcgaggaaagaaaaaatcgtctggaagctctttatgctttaccactttcacgactaaaagtgtattccacttatttactgatagctattctgtcagtaattttagctcagtttttagcgctttttggaatatttattgaacagttgggtaataaaaatgctttgagcttcttagaaattatgaaatctggcatgatttggcttgttgctgtcatatttgttttagcaatacttagtctgttacttgggcttgtgcctcgtttggcagaattaatttgggtatatcttgctttcttactttttatgacttatcttggaaaattattatctttgccaaaatggcttgaaaatttaagcatttataactatattcctaaattgccagttgagaaaatgaatcttcctaccgttttattcatattaattttatctgtcttcttagttttacttggctttggagcttatagaagacgcgatttaatcacggggtaa

SEQ ID NO: 8 - DNA, 1116 bp, Lactococcus lactis
  source 1..1116: mol_type = genomic DNA
atggctttaacagcaggtatcgttggtttaccaaacgttggtaaatcaactctttttaatgcaattacaaaagcaggcgcagaagctgcaaactatccttttgcaacaattgacccaaatgttgggatggtagaagtaccggatgaacgtttaaacaagttaacagagttgattaaacctaagaaaactgttccgacaacttttgaatttacagatattgctgggattgttaaaggggcttcacgcggagaaggtctaggaaataaatttcttgccaatattcgtgaagtagatgccatcattcacgttgttcgagcttttgatgatgaaaatgtaatgcgtgaaaataatcgtgaagatgcttttattgatccaatggcagacattgaaacaattaatcttgaattaattttggccgatttagaatcagtcaataaacgttatgcgcgtgttgaaaaagttgctcgtacggcaaaagataaagatgcggtcgcagaatttaatgttttgaaaaagctcaaaccggtacttgaagatggtaaatcagcacgaacaattgactttgacgaagatgaaataaaggttcttaaaagcttgttcttattgacaagtaaaccagttctttatgtagctaatgtttcagaagatgaagtaggcgaacctgataatatcgaatacgtgaaacaaattcgtgagtttgcggcgactgaaaatgctgaagttgctgtgatttctgctcgtgttgaagaagaaatctcagagttggaagatgatgaaaaagcagaatttttggaagcaattggcttaaaagaatctggtgttgatatgttgactcgtgcagcttaccaccttcttggacttgccacttactttactgctggtgaaaaagaagtccgtgcttggaccttcaagcgtggaatgaaagctccacaaatggcaggaattattcatacagactttgaaaaaggctttatccgcgcagtaactatgtcttatgatgatttgcttaaatacggttcagaaaaagctgttcgtgaagccggtcgcttgcgtgaagaaggaaaagaatatgttggtcaagatggcgacattatggaattccgtttcaacgtgtaa

SEQ ID NO: 9 - DNA, 411 bp, Lactococcus lactis
  source 1..411: mol_type = genomic DNA
atggatcgttatactaaaaaagtcattgcttgggatttaggaaagcgaatgactctagaattagtgcaaaggactttgaataaggcaatggaatcacaaaattatccagaagctgtgatgcttcattctgaccaaggaagtcagtatacgagtcatgagtatgaagagacaataaaaaactctggaatgactcactccttcagtcgtaagggctatccttatcataatgccagtcttgaatcttggcatggacatttaaaaagagagtgggtgtatcaatttaaatataagaactttgaagaagcctatcagagtattttctggtacatcgaagccttttataattcaaaacgaatccatcaaagtttagggtatcttacgcctaatcaatttgaaaaagaaatcacttaa

SEQ ID NO: 10 - DNA, 645 bp, Lactococcus lactis
  source 1..645: mol_type = genomic DNA
atgataagaagtgaatgtctcaaattaaaaaatagcttagggttttatttagtttttctctttactttattagagcttttaacggttcctatttatttagcttttggaagaagtcatgtttcaatgactgatttatcgctcatgatttttttgttttttccgttactggttacaattttgtctattctaatctttgaacaggagagtctggccaatcgtttccaagaaataaatgtaaataaaaaaagtagcagaatttggttatcaaagctaatagtagtggatttccttttgttctttccatcagcaatgatctggataattacgggagtttcacaggcagtagggcaacaaggaatgatgatcgcaacagctagctggttgatggcaatttttcttaatcattttcatcttttattgacctttataatcaatcgaggagggagcatgattatcgcgattattgaaatattactcattatttttgccagtaataaagttttattagcagcttattggtgtcccattgctttacctgttaattttatgataactgggcggtgtgcttatctgatagctgccgtagggtggattgttttatccacaataattcttgtagcattatctaaaaaaaagattagataa

SEQ ID NO: 11 - DNA, 729 bp, Lactococcus lactis
  source 1..729: mol_type = genomic DNA
atgaaaagaataatagcatcagaagcaataaaattaaaaaaatcaggaactcttagattggtattaattatcccttttgtgactctatttatagcatttcttatgggtggaatacagatttttagtgttttttcaatttattggtgggaaactggttttttattccttttgatgagtttgctttttctttatgatataaaatcagaggagcaagctggaaattttcaaaatgtgaaatggaaaaagctgagttggaaaattcatttggccaaaatgttgttgatttggctaagaggtatactagcgagcatagtcttgattattttgctttatttggttgcttttgtgtttcaaggtattgtagtggtggattttatgaaagtaagtgtggcattgattgctatattactagcagcttcttggaatttaccctttatatacttgattttcaagtggattaatacttacgtattgttagctgcgaataccttgatttgtttaattgttgccccttttgttgcacaaactccagtatggttcttgctaccatacacttatcactataaagttacagaaagtttgttaaatatcaaaccatcaggagatttgttaacagggaagataaatttcagtatttgggaagttttattaccatttggactttccatagttgtaacgataggagtttcgtatttacttaaaggagtgatagaacatgataagaagtga

SEQ ID NO: 12 - DNA, 678 bp, Lactococcus lactis
  source 1..678: mol_type = genomic DNA
atgcaggtaaaaattcaaaatctttctaaaacatataaagaaaagcaggtgctacaagatatcagttttgatattaaatctggaacagtctgtggtttattaggagttaacggtgcaggaaaatcaactttgatgaaaattttgtttggtttaatttctgcagatactggaaaaattttttttgatggacaagaaaagacaaataatcaacttggagccttaatcgaggctccagcaatatatatgaatttatctgctttcgataatcttaaaactaaggctttgctttttggaatttcagataagagaattcatgaaactctagaagtgattggtttggcagaaacaggaaagaaaagagcaggaaaattctctttagggatgaaacaacgtttgggaattggtatggctattcttacagaacctcaatttttaattcttgatgaacctactaatggtttggatcctgatggtattgcggagttgttaaacttaatcttaaaacttaaagctaaaggtgtgacaatcttgatttctagtcatcagttgcacgaaataagtaaagtagctagtcaaattattattttgaacaaaggtaagattcgttataatcgtgcgaacaataaagaagacgacattgaacagttattctttaagattgtgcatggaggaatgtga

SEQ ID NO: 13 - DNA, 687 bp, Lactococcus lactis
  source 1..687: mol_type = genomic DNA
gtgtataaaattttaatagttgatgatgatcaggaaattttaaaattaatgaagacagcattagaaatgagaaactatgaagttgcgacgcatcaaaacatttcacttcccttggatattactgattttcagggatttgatttgattttgttagatatcatgatgtcaaatattgaagggacagaaatttgtaaaaggattcgcagagaaatatcaactccaattatctttgttagtgcgaaagatacagaagaggatattataaacggcttaggtattggtggggatgactatattactaagccttttagccttaaacagttggttgcaaaagtggaagcaaatataaagcgagaggaacgcaataaacatgcagttcatgttttttcagagattcgtagagatttaggaccaattacattttatttagaagaaaggcgagtctgtgtcaatggtcaaacaattccactgacttgtcgtgaatacgatattcttgaattactatcacaacgaacttctaaagtttatacgagagaggatatttatgatgacgtatatgatgaatattctaatgcactttttcggtcaatctcggagtatatttatcagattaggagtaagtttgcaccatacgatattaatccgataaaaacggttcggggacttgggtatcagtggcatgggtaa

SEQ ID NO: 14 - DNA, 1344 bp, Lactococcus lactis
  source 1..1344: mol_type = genomic DNA
atgggtaaaaaatattcaatgcgtcgacggatatggcaagctgtcattgaaattatcataggtacttgtctacttatcctgttgttactgggcttgactttctttctacgacaaattggacaaatcagtggttcagaaactattcgtttatctttagattcagataatttaactatttctgatatcgaacgtgatatgaaacactacccatatgattatattatttttgacaatgatacaagtaaaattttgggaggacattatgtcaagtcggatgtacctagttttgtagcttcaaaacagtcttcacataatattacagaaggagaaattacttatacttattcaagcaataagcatttttcagttgttttaagacaaaacagtatgcctgaatttacaaatcatacgcttcgttcaatttcttataatcaatttacttaccttttcttttttcttggtgaaataatactcattattttttctgtctatcatctcattagagaattttctaagaattttcaagccgttcaaaagattgcattgaagatgggggaaataactacttttcctgaacaagaggaatcaaaaattattgaatttgatcaggttctgaataacttatattcgaaaagtaaggagttagctttccttattgaagcggagcgtcatgaaaaacatgatttatccttccaggttgctgcactttcacatgatgttaagacacctttaacagtattaaaaggaaatattgaactgctagagatgactgaagtaaatgaacaacaagctgattttattgagtcaatgaaaaatagtttgactgtttttgacaagtattttaacacaatgattagttatacaaaacttttgaatgatgaaaatgattacaaagcgacaatctccctggaggattttttgatagatttatcagttgagttggaagagttgtcaacaacttatcaagtggattatcagctagttaaaaaaacagatttaaccactttttacggaaatacattagctttaagtcgagcacttatcaatatctttgttaatgcctgtcagtatgctaaagagggtgaaaaaatagtcagtttgagtatttatgatgatgaaaaatatctctattttgaaatctggaataatggtcatcctttttctgaacaagcaaaaaaaaatgctggaaaactatttttcacagaagatactggacgtagtgggaaacactatgggattggactatcttttgctcaaggtgtagctttaaaacatcaaggaaacttaattctcagtaatcctcaaaaaggtggggcagaagttatcctaaaaataaaaaagtaa

SEQ ID NO: 15 - DNA, 2010 bp, Lactococcus lactis
  source 1..2010: mol_type = genomic DNA
ttgggtttatcagcaactgtgcatggggagacaacaaattcacaacagttactctcaaataatattaatacggaattaattaatcataattctaatgcaattttatcttcaacagagggatcaacgactgattcgattaatctaggggcgcagtcacctgcagtaaaatcgacaacaaggactgaattggatgtaactggtgctgctaaaactttattacagacatcagctgttcaaaaagaaatgaaagtttcgttgcaagaaactcaagttagttctgaattcagtaagagagatagcgttacaaataaagaagcagttccagtatctaaggatgagctacttgagcaaagtgaagtagtcgtttcaacatcatcgattcaaaaaaataaaatcctcgataataagaagaaaagagctaacttcgttacttcctctccgcttattaaggaaaaaccatcaaattctaaagatgcatctggtgtaattgataattctgcttctcctctatcttatcgtaaagctaaggaagtggtatctcttagacaacctttaaaaaatcaaaaagtagaggcacaacctctattgataagtaattcttctgaaaagaaagcaagtgtttatacaaattcacatgatttttgggattatcagtgggatatgaaatatgtgacaaataatggagaaagctatgcgctctaccagccctcaaagaaaatttctgttggaattattgattcaggaatcatggaagaacatcctgatttgtcaaatagtttaggaaattattttaaaaatcttgttcctaagggagggtttgataatgaagaacctgatgaaactggaaatccaagtgatattgtcgacaaaatgggacacgggacggaagtcgcaggtcagattacagcaaatggtaatattttaggagtagcaccagggattactgtaaatatatacagagtatttggtgaaaatctttcgaaatcggaatgggtagctagagcaataagaagagctgcggatgatgggaacaaggtcatcaatataagtgctggacagtatcttatgatttcaggatcgtatgatgatggaacaaatgattatcaagagtatcttaattataagtcagcaataaattatgcaacagcaaaaggaagtattgttgtcgcagctcttggtaatgatagtttaaacatacaagataaccaaacaatgataaactttcttaagcgtttcagaagtataaaggttcctggaaaagttgtagatgcaccgagtgtatttgaggatgtaatagccgtaggtggaatagatggttatggtaatatttctgattttagtaatattggagcggatgcaatttatgctcctgctggcacaacggccaattttaaaaaatatgggcaagataaatttgtcagtcagggttattatttgaaagattggctttttacaactactaatactggctggtaccaatatgtttatggcaactcatttgctactcctaaagtatctggggcactggcattagtagttgataaatatggaataaagaatcctaaccaactaaaaaggtttcttctaatgaattctccagaagttaatgggaatagagtattgaatattgttgatttattgaatgggaaaaataaagcttttagcttagatacagataaaggtcaggatgatgctattaaacataaatcgatggagaatcttaaagagtctagggatacaatgaaacaggaacaagataaagaaattcaaagaaatacaaataacaatttttctatcaaaaatgattttcataacatttcaaaagaagtaatttcagttgattataatattaatcaaaaaatggctaataatcgaaattcgagaggtgctgtttctgtacgaagtcaagaaattttacctgttactggagatggagaagattttttaccggctttaggtatagtgtgtatctcaatccttggtatattgaaaagaaagactaaaaattga

SEQ ID NO: 16 - DNA, 738 bp, Lactococcus lactis
  source 1..738: mol_type = genomic DNA
atgagaagatatttaatacttattgtggccttaatagggataacaggtttatcagggtgttatcaaacaagtcataaaaaggtgaggtttgacgaaggaagttatactaattttatttatgataataaatcgtatttcgtaactgataaggagattcctcaggagaacgttaacaattccaaagtaaaattttataagctgttgattgttgacatgaaaagtgagaaacttttatcaagtagcaacaaaaatagtgtgactttggtcttaaataatatttatgaggcttctgacaagtcgctatgtatgggtattaacgacagatactataagatacttccagaaagtgataagggggcggtcaaagctttgagattacaaaactttgatgtgacaagcgatatttctgatgataattttgttattgataaaaatgattcacgaaaaattgactatatgggaaatatttacagtatatcggacaccaccgtatctgatgaagaattgggagaatatcaggatgttttagctgaagtacgtgtgtttgattcagttagtggcaaaagtatcccgaggtctgaatgggggagaattgataaggatggttcaaattccaaacagagtaggacggaatgggattatggcgaaatccattctattagaggaaaatctcttactgaagcatttgccgttgagataaatgatgattttaagcttgcaacgaaggtaggaaactag

SEQ ID NO: 17 - DNA, 1245 bp, Lactococcus lactis
  source 1..1245: mol_type = genomic DNA
atgaataaaaaaaatataaaaagaaatgttgaaaaaattattgctcaatgggatgagagaactagaaaaaataaagaaaacttcgatttcggagagttgactctctctacaggattgcctggtataattttaatgttagcggagttaaaaaataaagataactcaaagatatatcagaaaaagatagacaattatattgaatatattgttagcaaactttcaacatatgggcttttaacaggatcactttattcgggagcagctggcattgcattaagtatcctacatttacgagaagatgacgaaaaatataagaatcttcttgatagcctaaatagatatatcgaatatttcgtcagagaaaaaattgaaggatttaatttggaaaacattactcctcctgattatgacgtgattgaaggtttatctgggatactttcctatctattattaatcaacgacgagcaatatgatgatttgaaaatactcattatcaattttttatcaaatctgactaaagaaaacaatggactaatatcgctttacatcaaatcggagaatcagatgtctcaatcagaaagtgagatgtatccactaggctgtttgaatatgggattagcacatggacttgctggagtgggctgtatcttagcttatgcccacataaaaggatatagtaatgaagcctcgttgtcagctttgcaaaaaattatttttatttatgaaaagtttgaacttgaaaggaaaaaacagtttctatggaaagatggacttgtagcagatgaattaaaaaaagagaaagtaattagggaagcaagtttcattagagatgcatggtgctatggaggtccaggtattagtctgctatacttatacggaggattagcactggataatgactattttgtagataaagcagaaaaaatattagagtcagctatgcaaaggaaacttggtattgattcatatatgatttgccatggctattctggtttaatagaaatttgttctttatttaagcggctattaaatacaaaaaagtttgattcatacatggaagaatttaatgttaatagtgagcaaattcttgaagaatacggagatgaaagtggcacgggttttcttgaaggaataagtggctgtatactggtattatcgaaatttgaatattcaatcaattttacttattggagacaagcacttttactttttgacgattttttgaaaggagggaagaggaaatga

SEQ ID NO: 18 - DNA, 1803 bp, Lactococcus lactis
  source 1..1803: mol_type = genomic DNA
atggatgaagtgaaagaattcacatcaaaacaattttttaatactttacttactcttccaagcaccttgaagttaatttttcagttggaaaaacgttatgcaatttatttaattgtgctaaatgctatcacagcttttgttccgttggctagtctttttatttatcaagatttaataaactctgtgctaggttcagggagacatcttatcaatattattatcatctattttattgttcaagtgataacaacagttctgggacagctggaaagttatgttagtggaaaatttgatatgcgactttcttacagtatcaatatgcgcctcatgaggactacctcatctcttgaattaagtgattatgagcaggctgatatgtataatatcatagaaaaagttactcaagacagcacttacaagccttttcagctatttaatgctatcattgttgtgctttcatcgtttatctcattgttatctagtctattttttattggaacatggaacattggggtagcaattttactccttattgttccagtattatctttggtactttttctcagagtgggacaattagagtttttaatccagtggcagagagcaagttctgaaagagaaacatggtatattgtatatttattgactcatgatttttcatttaaagaaatcaagttaaataatattagcaattacttcattcataaatttggaaaattaaagaaaggatttatcaaccaagatttagctattgctcgtaagaagacatatttcaatatttttcttgatttcattttgaatttgataaatattcttacgatatttgctatgatcctttcggtaagagcaggaaaacttcttataggtaatttggtaagtctcatacaagctatttctaaaatcaatacttattctcaaacaatgattcaaaatatttacatcatttataatactagtttgtttatggaacaactttttgagtttttaaagagagaaagtgtagttcacaaaaaaatagaagatactgaaatatgcaatcaacatataggaactgttaaagtaattaatttatcatatgtttaccctaattcgaatgcctttgcactaaagaatatcaatttatcctttgaaaaaggagaattaactgctattgtaggaaaaaatggttcagggaaaagtacactagtaaagataatttcaggattatatcaaccaactatgggaataatccaatacgacaaaatgagaagtagtttgatgcctgaggagttttatcagaaaaacatatcggtgctgttccaagattttgtgaagtatgagttaacgataagagagaatataggattgagtgatttgtcttctcaatgggaagatgagaaaattattaaagtactagataatttaggactcgattttttgaaaactaataatcaatatgtacttgatacgcagttaggaaattggtttcaagaagggcatcaactttcaggaggtcagtggcaaaaaattgcattagcaaggacattctttaagaaagcttcaatttatattttagatgaaccaagtgctgcactcgatcctgtagctgaaaaagaaatatttgattattttgttgctctttcggaaaataatatttcaattttcatttctcatagtttgaatgctgccagaaaagcaaataaaatcgtggttatgaaagatggacaggtcgaagatgttggaagtcatgatgtccttctgagaagatgtcaatactatcaagaactttattattcagagcaatatgaggataatgatgaataa

SEQ ID NO: 19 - DNA, 2982 bp, Lactococcus lactis
  source 1..2982: mol_type = genomic DNA
atgataaaaagttcatttaaagctcaaccgtttttagtaagaaatacaattttatctccaaacgataaacggagttttactgaatatactcaagtcattgagactgtaagtaaaaataaagtttttttggaacagttactactagctaatcctaaactctatgatgttatgcagaaatataatgctggtctgttaaagaagaaaagggttaaaaaattatttgaatctatttacaagtattataagagaagttatttacgatcaactccatttggattatttagtgaaacttcaattggtgttttttcgaaaagttcacagtacaagttaatgggaaagactacaaagggtataagattggatactcagtggttgattcgcctagttcataaaatggaagtagatttctcaaaaaagttatcatttactagaaataatgcaaattataagtttggagatcgagtttttcaagtttataccataaatagtagtgagcttgaagaagtaaatattaaatatacgaatgtttatcaaattatttctgaattttgtgagaatgactatcaaaaatatgaagatatttgtgaaactgtaacgctttgctatggagacgaatatagagaactatcggaacaatatcttggtagtctgatagttaatcattatttgatctctaatttacaaaaagatttgttgtcagatttttcttggaacacttttttgactaaagttgaagcaatagatgaagataaaaaatatataattcctctgaaaaaagttcaaaagtttattcaagaatactcagaaatagaaattggtgaaggtattgagaaactgaaagaaatatatcaggaaatgtcacaaattcttgagaatgataattatattcaaattgatttaattagtgatagtgaaataaattttgatgttaaacaaaagcaacaattagaacatttagctgagtttttaggaaatacgacaaaatctgtaagaagaacatatttggatgactataaggataaatttatcgaaaaatatggtgtagatcaagaagtacaaataacagaattatttgattctacatttggcataggagctccatataattataatcatcctcgaaatgacttttatgagtccgaaccgagtactctatactattcagaagaggagagagaaaagtacctcagcatgtatgtagaagccgttaaaaatcataatgtaattaatcttgacgacttagagtctcattatcaaaaaatggacttagaaaagaaaagtgaacttcaagggttagaattatttttgaatttggcaaaggagtatgaaaaagatatttttattttaggggatatcgttggaaataataatttgggaggggcatcaggtagattttctgcactctctccggagttaacaagttatcatagaacgatagtagattctgtcgaaagagaaaatgagaataaagaaattacatcgtgtgaaatagtatttcttccagaaaatatcagacatgctaacgttatgcatacatcaattatgaggaggaaagtacttccattttttacaagtacaagtcacaatgaagttctgttaactaatatctatattggaatagacgaaaaagaaaaattttatgcacgagacatttcaactcaagaggtattgaaattctacattacaagcatgtacaataaaacgttattcagtaatgagctaagatttctttacgaaatttcattagatgacaagtttggtaatttaccttgggaacttatttacagagactttgattatattccacgtttagtatttgacgaaatagtaatatctcctgctaaatggaaaatttggggaagggatgtaaatagtaagatgacaataagagaacttattcaaagcaaagaaattcccaaagagttttatattgtcaatggagataataaagtttatttatcacaggaaaacccattggatatggaaattttagagtcggcgataaagaagagctcaaaaagaaaagattttatagagctacaagaatattttgaagatgaaaatatcataaataaaggagaaaaggggagagttgccgatgttgtagtgccttttattagaacgagagcattaggtaatgaagggagagcatttataagagagaaaagagtttcggttgaacggcgtgaaaaattgccctttaacgagtggctttatctaaagttgtacatttctataaatcgtcaaaatgaatttttactgtcgtatcttccagatattcagaaaatagtagcaaacctgggtggaaatctattcttcctaagatatactgatcctaaaccacatattagattgcgtataaaatgttcagatttatttttagcttacggatctattcttgaaatcttaaaaaggagtcggaaaaataggataatgtcaacttttgatatttctatttatgatcaagaagtagaaagatatggtggatttgatactttagagttatccgaagcaatattttgtgccgattctaaaattattccaaatttgcttacattgataaaagatactaataatgattggaaagtcgatgatgtatcaatcttggtgaattatttatatctgaaatgcttctttcagaatgataacaaaaagattcttaattttttgaatttagttagtcctaaaaaggttaaagaaaatgtcaatgaaaagattgaacattatcttaagcttctgaaagttaataatctaggtgaccaaattttttatgacaagaattttaaagaattaaagcatgccataaaaaatttatttttaaaaatgatagctcaagattttgaacttcagaaagtttattcaattattgacagtatcattcatgtccataataaccgactaattggtattgaacgagataaagagaaattaatttattacacacttcaaaggttgtttgtttcggaagaatacatgaaatga

SEQ ID NO: 20 - protein, 57 aa, Lactococcus lactis
MSTKDFNLDLVSVSKKDSGASPRITSISLCTPGCKTGALMGCNMKTATCHCSIHVSK

SEQ ID NO: 21 - DNA, 318 bp, Lactococcus lactis
  source 1..318: mol_type = genomic DNA
atgaatgatttattttatcatcggctaaaggaactagttgaatcaagtggtaaatctgcaaatcaaatagaaagggaattgggttaccctagaaattctttgaataattataagttgggaggagaaccctctgggacaagattaataggactatcagagtattttaatgtgtctccaaaatatctgatgggtataattgatgagcctaatgacagttctgcaattaatctttttaaaactctaactcaagaagagaaaaaagaaatgtttataatttgtcaaaaatggctttttttagaatatcaaatagagttataa

SEQ ID NO: 22 - DNA, 768 bp, Lactococcus lactis
  source 1..768: mol_type = genomic DNA
atgatgaaaaaaggaatttttgtaattactatagtgatatctatagcattgataattggaggtttttatagttataattctaggataaataatctttcaaaagctgataaaggaaaagaagttgtaaaaaatagcagtgaaaaaaatcagatagaccttacctataaaaagtattataaaaatttaccaaaatcagttcaaaataaaatagatgatatttcatccaaaaataaagaagttactttaacttgtatttggcaatctgattcagttatttctgaacaatttcaacaaaacttacaaaaatattatggaaataagttttggaacatcaaaaatatcacttacaatggcgaaactagtgaacaattattggctgaaaaagttgaaaaccaagtattagccactaatcctgatgttgttttatatgaagctccactttttaatgataaccaaaacattgaagcaacagcctcactgactagtaatgagcaacttataacaaatttggctagtgcaggagcggaggtaatagttcaaccctctccaccgatttatggtggtgttgtgtaccccgtacaagaagaacagtttaaacaatctttatctacaaagtatccctatatagactactgggctagttacccagacaaaaattctgatgaaatgaaggggctgttttctgatgatggagtatatagaacattaaatgcttcggggaataaggtttggctagattatattactaaatattttacagcaaactaa

SEQ ID NO: 23 - DNA, 780 bp, Lactococcus lactis
  source 1..780: mol_type = genomic DNA
atgcaggaaacacaggaacagacgattgatttaagagggatttttaaaattattcgcaaaaggttaggtttaatattatttagtgctttaatagtcacaatattagggagcatctacacattttttatagcctccccagtttacacagcctcaactcaacttgtcgttaaactaccaaattcggataattcagcagcctacgctggacaagtgaccgggaatattcaaatggcgaacacaattaaccaagttattgttagtccagtcattttagataaagttcaaagtaatttaaatctatctgatgactctttccaaaaacaagttacagcagcaaatcaaacaaattcacaagttattacgcttactgttaaatattctaatccttacattgcacaaaagattgcagacgagactgctaaaatatttagttcagacgcaccgaaactattgaatgttactaacgttaatattctatccaaagcaaaagctcaaacaacaccaattagtcctaaacctaaattgtatttagcgatatctgttatagtcggactagttttaggtttagccattgctttattgaaagaattgtttgataacaaaattaataaagaagaagatattgaagctctggggctcacggttcttggtgtaacaacctatgctcaaatgagtgattttaataagaatacaaataaaaatggcacgcaatcgggaactaagtcaagtccgcctagcgaccatgaagtaaatagatcatcaaaaaggaataaaagatag

SEQ ID NO: 24 - DNA, 696 bp, Lactococcus lactis
  source 1..696: mol_type = genomic DNA
atggctaaaaataaaagaagcatagacaacaatcgttatattattaccagtgtcaatcctcaatcacctatttctgaacaatatcgtacgattcgtacgaccattgattttaaaatggcggatcaagggattaaaagttttctagtaacatcttcagaagcagctgcaggtaaatcaaccgcgagtgctaatatagctgttgcttttgcacaacaaggtaaaaaagtacttttaattgatggtgatcttcgtaaaccgactgttaacattacttttaaagtacaaaatagagtagggttaaccaatattttaatgcatcaatcttcgattgaagatgccatacaagggacaagactttctgaaaatcttacaataattacctctggtccaattccacctaatccatcggaattattagcatctagtgcaatgaagaatttgattgactctgtgtccgatttctttgatgttgttttgattgatactccacctctctctgcagttactgatgctcaaattttgagtagttatgtaggaggagtggttcttgttgtacgtgcctatgaaacaaaaaaagagagtttagcaaaaacaaaaaaaatgctggaacaagttaatgcaaatattttaggagttgttttgcatggggtagactcttctgactcaccgtcgtattactactacggagtagagtaa

SEQ ID NO: 25 - DNA, 687 bp, Lactococcus lactis
  source 1..687: mol_type = genomic DNA
atggaattttttgaggatgcctcatcacctgaatcggaagagcctaagttagtagaattaaaaaatttttcttatagagagctaattataaaaagagcaattgatatcctaggaggattagcaggttcagttttatttcttattgcggctgcattgctttatgtgccttacaaaatgagctcaaaaaaagatcaagggccaatgttctataaacaaaaacggtatggaaaaaacggtaaaattttttatattttgaaatttagaacaatgattcttaatgccgagcagtatctagaacttaatccagatgttaaagctgcttaccatgccaacggcaataagctagaaaacgatccacgggtaacgaagattggctcatttataagacgacactcaattgatgaactgccacaatttatcaatgttcttaaaggggatatggcattggttggcccaagaccaattttgctttttgaagcgaaagaatatggggagcgcctctcttacttactcatgtgtaaacctggaattactggttattggacaacacatggtcgaagtaaagttctttttcctcaacgagcagatttagaactctattacctccagtaccatagtaccaaaaacgatatcaagcttctagtactcacaattgtacaaagtattaacggatcggacgcatattaa

SEQ ID NO: 26 - DNA, 765 bp, Lactococcus lactis
  source 1..765: mol_type = genomic DNA
atgattgatattcattgccatattttaccgggtatagatgatggagctaaaacttctggagatactctgacaatgctgaaatcagcaattgatgaagggataacaactatcactgctactcctcatcataatcctcaatttaataatgaatcaccacttattttgaaaaaagttaaggaagttcaaaatatcattgacgaacatcaattaccaattgaagttttacccggacaagaggtgagaatatatggtgatttattaaaagaattttctgaaggaaagttactgacagcagcgggcacttcaagttatatattgattgaatttccatcaaatcatgtgccagcttatgctaaagaacttttttataatattcaattggagggacttcaacctattttggtccaccctgagcgtaatagcggaatcattgagaaccctgatatattatttgattttattgaacaaggagtactaagtcagataacagcttcaagtgtcactggtcattttggtaaaaaaatacaaaagctgtcatttaaaatgatagaaaaccatcttacgcattttgttgcatcagatgcgcataatgtgacgtcacgtgcatttaagatgaaggaagcgtttgaaattattgaagatagttatggttctgatgtatcacgaatgtttcaaaataatgcagagtcagtgattttaaacgaaagtttttatcaagaaaaaccaacaaagatcaaaacaaagaaatttttaggattattttaa

SEQ ID NO: 27 - DNA, 450 bp, Lactococcus lactis
  source 1..450: mol_type = genomic DNA
atgaaaatagcattagtaggttccagcggtggccatttgacacacctgtatttgttaaaaaagttttgggaaaacgaagatagattttgggtcacatttgataaagcagatgcaaaatctatattgaaagaagaaagattttatccttgttattatcccacaaatagaaatgtaaaaaacacgataaaaaataccattcttgcatttaaaatacttagaaaagaaaaaccagatttgattatttcgagtggtgctgcggtagccgttccttttttttggttaggtaaactattcggtgcaaagacagtctatattgaaatatttgaccggatcgataaaccaaccttaacaggaaaattagtttatccagttactgataagtttatagttcaatgggaagagttaaaaaaagtttaccctaaagcaattaatttaggaggaattttctaa

SEQ ID NO: 28 - DNA, 507 bp, Lactococcus lactis
  source 1..507: mol_type = genomic DNA
atgatttttgtaacggttggaactcacgaacaaccatttaatcgactcattcaaaaaattgatgaacttgtacgcgatggtgaaatcgaagacgatgtattcatgcaaattgggtactcaacttatgaacccaaatatactaaatgggaaaaggttattggatatgagactatggaaagatgtatgaatgaagcgagtacgattattactcatggcggaccatctacctatatgcaagtattacaactaggtaaaattccgatagttgttccacggcaaatgaaatttgatgagcatataaatgatcatcaaatttgggtaagtaaacaggttgtgaaaaagggatactcattgattttgtgcgaagatgttgaagacattctcgaaaatattattagctccaaaatttcagataccttacaaaaaaatgtaaatcacaacactgaattcataaaattattcagtgctgaaatttaccagctatttataaaaagtgagaagatatga

SEQ ID NO: 29 - DNA, 987 bp, Lactococcus lactis
  source 1..987: mol_type = genomic DNA
atggttaaattttctataattattccagtatataacttagaagattatttatatcgctgtttagaatctgttctcaatcaagattataatgattttgagattatacttattaatgatggttcagatgataattcacttaatattatcgaagaatttaaaaatcaatattctagtaaaataaaagtaatttctcaagtgaatcaaggagtatcatcagcaagaaataagggacttcaagaagctgaaggggagtatataatttttatagatggggatgactacattgatagtaatcatttaagtaatattcttgaatatataggaaaatcaaaaaattcctttattctaaatagtctatttgtagagaccggggaaactacttgggttattcccaaagcaagtaagaattatgattgtagtttttatggaactcttatgaatattttagataatcatagatatcaaggctttttgtttaataaaatatttagtaattcagtaataaaaagtaatgaattgaagtttaaagaaaatttatattatgcggaagatacggagtttgttattcgataccttttggagttgcaaaagagagaatcggatttagttgctaatataattaattctccaacatatcattatgttcaaataaaaagtagtgctactcaccaatttaatatcagacaattttctctagtaaattctatggaggaaattcaatgtaatctagaaaaaatgaaatcaataaataaagaagttttgtatgtagtacaatcaaatttaattcagtcagtattgaaaatgataagattatctagaataaatggtgtagttaatgaacatttggaagattcattagataaaatcgtaacaaattcatgggataatattgaaactatctggaaatctcaaagaaagatttactctaaggtatttttaacactaagaattattcaggaaaaagttaagggtaagaaaatcaaatag

SEQ ID NO: 30 - DNA, 867 bp, Lactococcus lactis
  source 1..867: mol_type = genomic DNA
gtgataattatacctatcttaatttttattacccttataggagcaggggcttatgccttaagagattcacttattcctactgaacatacgaaaacaaatagttcggatcaaccgaccaaaacttcggtttctaacggttacgtggagcaaaaaggtgaagaagctgctgtgggtagtatagcacttgtagatgacgctggagtaccagaatgggttaaagttccctcaaaggtaaatttagataaatttactgatttatctacgaataatatcactatttatcgaattaacaatccggaagtcttaaaaacagttaccgatcgtacggatcaacggatgaaaatgtcagaagttatagctaagtatcctaatactttgattatgaatgcttccgcttttgatatgcagacaggacaagtagctggatttcaaattaataatggaaagttgattcaagactggagtccaggtacaacgactcagtatgcttttgttattaacaaagatggttcgtgcaaaatttatgattcaagtacacctgcttcaactattattaaaaacggagggcaacaagcctatgattttggtactgcaattatccgtgatggtaaaattcaaccaagtgatggctcagtagattggaagatccatatttttattgcgaatgataaagataataatctctatgctattttgagtgatacaaatgcaggttatgataatataatgaaatcagtgtcaaatttgaagctccaaaatatgttattacttgatagtggtggttcaagtcaactatctgtcaatggtaaaacgattgttgctagtcaagatgatcgagccgtaccggattatattgtgatgaaataa

SEQ ID NO: 31 - DNA, 903 bp, Lactococcus lactis
  source 1..903: mol_type = genomic DNA
atgaatcaaaaaaagaggcgtcattatcgtaagaaaaaatacacagtactaaaagttatttcaattatttttgtattagtaattatttctgttgcttctatagcctacgtagcttatagaaatgttgaatcaaccttttcaacatcatatgaaaatttccctaaaacaacaagtattgacttaaaaaaatctaaaacattcaccacacttatcattgcaactggtaaaaataattctaaaaattcagcttatgctactgttttagcttcaacgaatgtaaagacaaatcaaactactttcatgaacttcccagtttttgcgacactgcctaatcaaaaaacaatcactgaagtttacaatacgaatggagatgatggaattttccagatggttaaagacctattgaatgcgtccattaacaaagtaattcagatcgatgttaataaaatgggatcacttgtacaggccactggtggaatcaccatgcaaaatccaaaggcattcaatgctgaaggttatgagtttaaacaaggaactgttaatttacaaactgctgatcaagtccaagcctatatgacacaaattgacgatactgatttggatgcttcaatcactcggattcaaaatgtctcaatggaactctacgtaaatattaaaaaaattgctcatatgaaaaaacttgaaagtttcaattactatcgagaaattctctatgctttttcaaacactgttaaaaccaatataagtttcaatgatgctaaaacgatcgttatgagctacagtaaggctctaaagaataccagcaagctcaatctacatacaacagatgaaaatggagctaaggtcgtttctcaaacagaattagactcagtcaaaaccctttttgaaaaatctctaaaataa

SEQ ID NO: 32 - DNA, 1431 bp, Lactococcus lactis
  source 1..1431: mol_type = genomic DNA
ttgagtaacacaggaataaaagtaactaataaccaaatactaataagaaaagtaacagttatatttttgcttttttcaggaatttgggtaggagctgcaacaagtttttttgagatttctttagtgttttctgtattagctggtattataagctcaaatttactagaaaatgaatttgttccgtattcagttattttaatactggtttttcaaaatttattgataggtactgggtctcatttaacagggaatctgtcaggtttaacttatctcactcaagttccgatggtttttgtttggactattaatctctgtttgaaaaaggtagataaattatctaaagttgatatttcttttatagttcttatgatattttctttgtcatctttggcatttggacgagggccaattcaggcaattatttcgaacttaagagatttatcgacattttattttacttatcgtataggtaaaagatttatcaaaactgaagaaatatttgcgaggtttataaagaaaattctttatttaggaatatttgtagttttaattggtattatcttatacttaggaggctatcctctaaacaaatttttgggaatagatgaaatttactacgctaagggggtaactactttacttaataattttgatggcagatttggatcagatgtatttggaatttccgtaacacgtatgggatcaatttattttgaaccaataaatttggggtatttaatattttctatgctcattatatcctttattttctttaatacccaaaaattaaaatatataaatttatatagactgattttattgataggtggaatgttaacttttgggaaaggtgctatgcttctagctataggggtgatggttgcaggtatcggacataaattatttttaaaattcttttcaagaagtaatgaaatgaatgtttttagaaatctttttatattgttaactattattatgtttattggtggaaattattatttcaaaacttttggaggagctgtagggaatcacttttatgcaatccaagggacattggatagtataagtcatcgaccaattggttttggattaggtgtgggaggaaacgcctcagcagtatttacagggggagaacttgattttactactggatcagaaacagccttgttatcatttgtataccaaataggtgtacaaggtgctattgctttaatatgtgtattctactttatgagtaaagaagtgttggaaaaagtacagaagaattcacaattcaaaaatagatttttattttatgttccaatgatattgatttttgttagtatatatcaagctaatacatataccccacaatgtataacgttgttaatgattactttgggaggatttgtaggaatgagagacaggagaaggaaaaaatataatggttaa

SEQ ID NO: 33 - DNA, 702 bp, Lactococcus lactis
  source 1..702: mol_type = genomic DNA
atgataccaaaagtaatacactattgctggttcggagggcaacctttaccagaatctgcgctaaaatgtattgaaagttggagaaggttttgtccagattatgaaataaaacaatggtctgagaaaaactatgatgtaaataaaattcaatatacaaaagaagcgtacgaaaagaaacgttatgcttttgtcacggatgttgcaaggcttgatatcatttatagtgaggggggcatttatcttgacactgatgttgaactgataaaacctttggatgatttgcttgtcaatcaagcatatatgggaatggaaactgctggtcgtgtaaataccggccaaggatttggagctataaaaaaccaccaaatagttaaagcaaatttagaggtttatgctgaacttgagtttgatggtacgactacttgtgtgacttacacaactaatttgttaaaaagatttggtttacaaaaaaaagatattaaccaggatttacaaggaataactatccttccgacagattatttatgtccattaagtcttgaaactaggaaattagtaattacagaaaatacattttctattcatcactatgatggtggttggaaaaaaggaaaagataaatttttatctctaaaaattaaaattcgacgctggattggtgataacttttatgagtcgataaaaacgaagttgaagggatag